(19) United States
(12) Patent Application Publication
(10) Pub. No.: US 2026/0273713 A1
(43) Pub. Date: Sep. 17, 2026

(54) DRIVING TOOL

(71) Applicant: MAKITA CORPORATION, Anjo-shi (JP)

(72) Inventors: Nobuyuki HOSHIYAMA, Anjo-shi (JP); Masaya NAGAO, Anjo-shi (JP)

(73) Assignee: MAKITA CORPORATION, Anjo-shi (JP)

(21) Appl. No.: 19/562,398

(22) Filed: Mar. 10, 2026

(30) Foreign Application Priority Data
Mar. 12, 2025 (JP) 2025-039249
Mar. 12, 2025 (JP) 2025-039256
Mar. 12, 2025 (JP) 2025-039259
Mar. 12, 2025 (JP) 2025-039262

(51) Int. Cl. B25C 1/06; B25C 1/00; B25C 1/04

(52) U.S. Cl. CPC B25C 1/06; B25C 1/047; B25C 1/008

(57) ABSTRACT

An electric driving tool includes a gear housing that houses a reduction gear train and a main body housing that houses the gear housing. A first bearing supporting the lower portion of a motor shaft is directly held by the main body housing. A bearing holder holds a second bearing supporting the upper portion of the motor shaft that is supported by both the gear housing and the main body housing. This configuration suppresses motor shaft misalignment, reduces core rubbing, and lowers weight by eliminating a motor housing.

### CROSS-REFERENCE

This application claims priority to Japanese Patent Application Nos. 2025-039256, 2025-039249, 2025-039259, and 2025-039262, each filed on Mar. 12, 2025. The entire contents of each of these applications are incorporated herein by reference.

### TECHNICAL FIELD

The present invention generally relates to an electric driving tool.

### BACKGROUND

A gas spring type driving tool that uses a thrust power of compressed gas to drive a driving member is well known. Such a tool includes a piston that moves downward in a driving direction under gas pressure, a driver positioned at a lower surface center of the piston, and a lift mechanism that returns the driver from a lower moving end to an upper standby position. The lift mechanism has a wheel with engaging portions that sequentially engage a plurality of rack teeth disposed on the driver, and an electric motor that rotates the wheel via a reduction gear train.

In this type of the gas spring type driving tool, weight reduction is required. In the prior art, a motor housing is housed in a main body housing. By omitting the motor housing, the driving tool can be made lighter. Furthermore, in the prior art, the electric motor is directly supported by the main body housing without the motor housing.

Furthermore, the gas spring type driving tool is well known, which uses the thrust power of the compressed gas to drive a driving member, which is particularly suitable for driving a driving member (fastener) into concrete. The driving tool has a tubular contact top at the tip end of the driving nose portion. The driving member is guided around the entire circumference by the contact top to ensure a stable posture for ejection.

The contact top is movable along the driving direction relative to the driving nose. During a driving operation, the contact top is pressed against and moved relative to a workpiece to enable a switch lever to be pulled. A driving operation of the driving tool main body is performed on the condition that the contact top is turned on and the switch lever is pulled.

In a driving tool for driving nails (driving members) into concrete, a magazine can be detached from the tool main body in order to remove driving member stuck in the nose portion. The magazine disclosed in the prior art is attached to the tool main body by engaging a tip portion of the magazine in a feed direction with the nose portion and engaging an actuator on the rear side in the feed direction with the tool main body. The magazine can be removed from the tool main body by moving the actuator to an unlocking side and moving the rear side of the actuator in a removing direction.

Furthermore, a magazine that slidably engages a slide base portion protruding from the nose portion in a lateral direction is well known. The magazine is attached by an engagement of an actuator on the rear side of the slide base with a magazine lock portion on the rear side of the magazine. In a removal of the magazine, the magazine is slid by moving the actuator toward an unlocking side to disengage the engaging portion with the lock portion. Then, the magazine can be removed by sliding it in the removal direction.

In the prior art, a gas spring type driving tool includes a piston that moves downward in the driving direction owing to the gas pressure, a driver installed at the lower surface center of the piston, and a lift mechanism that returns the driver from the lower moving end to the upper standby position. The lift mechanism has a wheel with engaging portions that sequentially engage a plurality of rack teeth on the driver, and an electric motor that rotates the wheel via a reduction gear train.

### SUMMARY

In another prior art, the weight can be reduced by the amount corresponding to the motor housing compared to the conventional configuration. However, the bearing that supports the motor shaft is held almost directly by the main body housing. As a result, motor shaft misalignment may occur impact, causing rotor-stator contact (core rubbing). The present disclosure aims to reduce the weight of the driving tool by omitting the motor housing, and at the same time, to more reliably suppress the misalignment of the motor shaft.

In the prior art, the driving nose by which the contact top is displaceably supported receives a large impact through the contact top, especially when nail jamming occurs. In the present disclosure, the durability of the nose portion that supports the contact top can be improved.

In the prior art, the impact during driving is amplified and acts on the lock portion because the magazine lock portion is configured to lock the magazine to the tool main body by the lock portion provided on the rear side in the feeding direction of the driving member. Therefore, it is necessary to increase the durability of the lock portion against the impact during driving. In the present disclosure, the durability of the lock portion for securing the detachable magazine lock portion in its mounted position can be increased.

In the conventional driving tool which has a lift mechanism, the engaging portion of the wheel engages the rack teeth of the driver from below, and accordingly the driver is subjected to a pulling force in the direction of approaching the wheel side via the engaging portion. This pulling force acts as an external force to tilt the driver around its axis. Therefore, especially for a driver having a generally circular cross-section of the driver main body, it is necessary to restrict the rotation of the driver body around its axis to improve durability. In the present disclosure, the durability of the driver can be improved.

According to one aspect of the present disclosure, an electric driving tool has a driver that drives a driving member, a lift mechanism that returns the driver to a direction opposite to the driving direction, and a reduction gear train that reduces the output of the electric motor and transmits it to the lift mechanism. The electric driving tool has a gear housing that houses the reduction gear train and a main body housing that houses the gear housing. Furthermore, the electric driving tool has a first bearing that is directly held in the main body housing and supports a first portion of the motor shaft of the electric motor, and bearing holder that holds a second bearing supporting a second portion of the motor shaft and engages the gear housing.

Accordingly, omitting the motor housing reduces the weight of the driving tool and suppresses the motor shaft misalignment, thereby reducing rotor-stator contact (core rubbing).

### BRIEF DESCRIPTION OF THE DRAWINGS

FIG. 1 is a left side view of a driving tool according to an embodiment of the present disclosure.

FIG. 2 is a left side view of the driving tool with a magazine attached, illustrating an internal structure of the driving tool.

FIG. 3 is a left side view of the driving tool with the magazine detached, illustrating the internal structure of the driving tool.

FIG. 4 is a partial right side view of a retention mechanism and an adjustment mechanism for a contact top.

FIG. 5 is an exploded perspective view of the retention mechanism for the contact top.

FIG. 6 is an enlarged cross-sectional view of the retention mechanism for the contact top, illustrating the engagement between a stopper surface and a lock surface.

FIG. 7 is a perspective view of the adjustment mechanism and retention mechanism for the contact top, as viewed from the rear left side.

FIG. 8 is a partial left side view of a lift mechanism.

FIG. 9 is an exploded perspective view of the lift mechanism.

FIG. 10 is an exploded perspective view showing a bearing holder and left-right half-split housings, illustrating how the bearing holder is supported by the half-split housings when assembled.

FIG. 11 is a lateral cross-sectional view of the tool main body, taken along line XI-XI in FIG. 8.

FIG. 12 is aside view of a driver alone.

FIG. 13 is an enlarged perspective view of the driver at a tip end side, as viewed in a direction indicated by an arrow XIII in FIG. 12.

FIG. 14 is a cross-sectional view of an E-region of the driver, taken along line XIV-XIV in FIG. 13.

FIG. 15 is a cross-sectional view of an F-region of the driver, taken along line XV-XV in FIG. 12.

FIG. 16 is a longitudinal cross-sectional view of a driver guide, taken along line XVI-XVI in FIG. 11.

FIG. 17 is a longitudinal cross-sectional view of a contact top, taken along line XVII-XVII in FIG. 11.

FIG. 18 is a left side view of a magazine alone.

FIG. 19 is a cross-sectional view of the magazine taken along line XIX-XIX in FIG. 18, illustrating a state where a magazine holder is attached to the magazine main body.

FIG. 20 is an exploded perspective view of the rear of the magazine, illustrating the attachment of a clip.

FIG. 21 is a perspective view of tool main body as viewed from the below, illustrating a state where the magazine is removed from a nose portion of the tool main body.

FIG. 22 is an enlarged view of a magazine lock, illustrating that the magazine lock is in a locked state.

FIG. 23 is an enlarged perspective view of the magazine lock, illustrating that the magazine lock is in an unlocked state.

FIG. 24 is a perspective view of the magazine lock as viewed from a left side, illustrating that an actuator is omitted.

FIG. 25 is a perspective view of the magazine lock as viewed in a direction indicated by an arrow XXV in FIG. 24, illustrating that the magazine lock is viewed from the lower right.

FIG. 26 is a right side view of the magazine lock, illustrating the magazine is detached from the tool main body.

FIG. 27 is another embodiment of a retention mechanism of the contact top.

FIG. 28 is a further another embodiment of the retention mechanism of the contact top.

### DETAILED DESCRIPTION

The detailed description set forth below, when considered with the appended drawings, is intended to be a description of exemplary embodiments of the present disclosure and is not intended to be restrictive and/or representative of the only embodiments in which the present disclosure can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the disclosure. It will be apparent to those skilled in the art that the exemplary embodiments of the disclosure may be practiced without these specific details. In some instances, these specific details refer to well-known structures, components, and/or devices that are shown in block diagram form in order to avoid obscuring significant aspects of the exemplary embodiments presented herein.

According to another aspect of the present disclosure, the bearing holder has a supported portion that protrudes from the gear housing and is supported by the main body housing. Therefore, the bearing holder engages the gear housing and is supported by the main body housing via the supported portion, thereby more reliably reducing the misalignment of the second bearing.

According to another aspect of the present disclosure, the bearing holder has an anti-rotation portion that engages the main body housing. Thus, the bearing holder is prevented from rotating relative to the main body housing.

According to another aspect of the present disclosure, the bearing holder is formed of a single member having a first annular portion and a second annular portion. The first annular portion is supported by the main body housing and the second annular portion fits into the gear housing. Accordingly, the bearing holder is supported by both the main body housing and the gear housing.

According to another aspect of the present disclosure, the first annular portion of the bearing holder has the anti-rotation portion with a convex or concave shape on an outer peripheral surface thereof, and the anti-rotation portion is configured to engage the main body housing to prevent the bearing holder from rotating relative to the main body housing. Therefore, the bearing holder is prevented from rotating relative to the main body housing by the anti-rotation portion of the first annular portion.

According to another aspect of the present disclosure, the stator of the electric motor is directly supported by the main body housing. Accordingly, the misalignment of the stator with respect to the main body housing is suppressed.

According to another aspect of the present disclosure, the main body housing is divided into two half housings (left-right half-split housings) along the thickness direction of the tool main body. Therefore, the main body housing has a half-split structure, whereby assembly and maintenance of the electric motor and its peripheral components are ensured.

According to another aspect of the present disclosure, the two sections of the main body housing (left-right half-split housings) are combined with each other by a first fixing element and a second fixing element. The first fixing element is located on a first plane perpendicular to the axial direction of both the motor shaft and the first bearing. The second fixing element is located with the second bearing on a second plane perpendicular to the axial direction of both the motor shaft and the second bearing. Accordingly, the misalignment of the first bearing and the second bearing relative to the main body housing is more reliably reduced.

According to another aspect of the present disclosure, the bearing holder is made of aluminum. Therefore, the driving tool is reduced in weight.

According to another aspect of the present disclosure, the electric driving tool has a piston that is moved by a lift mechanism and an accumulation chamber in which gas pressure is increased by the piston, and the driver drives the driving member utilizing the gas pressure in the accumulation chamber. Accordingly, in the gas-spring-type driving tool, core rubbing is suppressed while weight reduction is achieved.

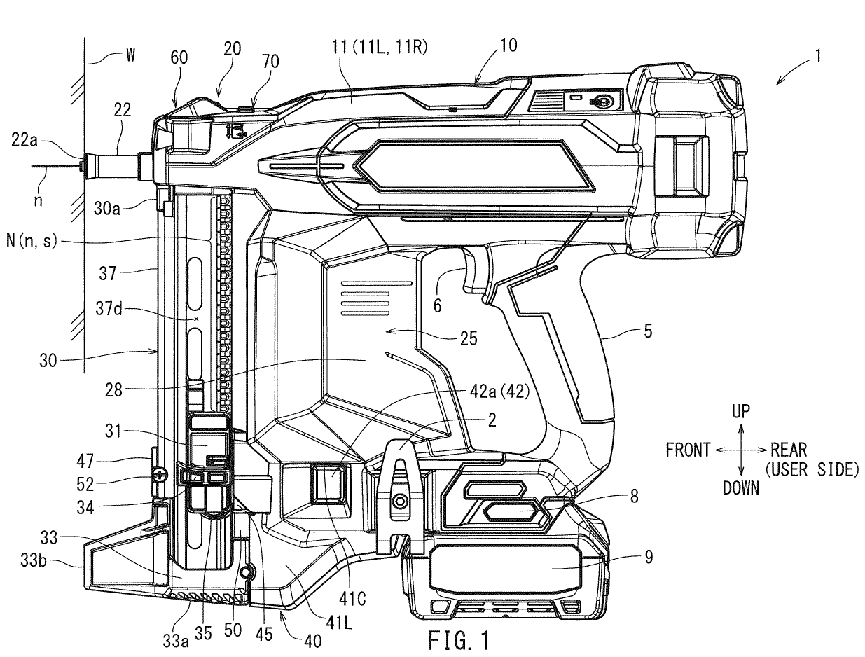

Next, one of the embodiments of the present disclosure will be described. As shown in FIGS. 1-3, an example of a driving tool 1 is a gas spring type driving tool 1 that uses gas pressure in an accumulation chamber behind a cylinder as a thrust force for driving a driving member n (fastener n). In this specification, the term ‘driving member’ refers to a fastener, such as a nail or pin, that is driven into a workpiece. The driving tool 1 is, for example, a concrete nailer that drives driving member n into concrete (material W to be driven). In the following description, the orientation of each part will be specified for the case where the driving tool 1 is held in the posture for driving member n into the material W (wall surface) to be driven as shown in FIG. 1. A user of the driving tool 1 is generally located behind the driving tool 1 in FIG. 1. Therefore, the driving direction of the driving member n is a forward direction and a direction opposite to the driving direction is a rearward direction. An up-down direction and a left-right directions are based on the user. The driving tool 1 has a removable magazine 30. A plurality of driving members n are loaded in the magazine 30. The plurality of driving members n are loaded in the form of flat-type connected driving members n, which are temporarily joined in parallel on a collated strip s made of resin.

The driving tool 1 has a tool main body 10. The tool main body 10 has a cylinder 12 housed in a generally tubular main body housing 11. A piston 13 is housed in the cylinder 12 so as to be reciprocatable in the front-rear direction. A driver 15 for driving the driving member n is coupled to the front center of the piston 13. The driver 15 is a long rod-shaped member extending forward.

The tool main body 10 has a nose portion 20 at the front. The nose portion 20 has a driving passage 20a. A front portion of the driver 15 enters into the driving passage 20a. The nose portion 20 has a driver guide 21 coupled to the front of the main body housing 11 and a tubular contact top 22 protruding forward from the driver guide 21. A tip portion of the contact top 22 is an ejection port 22a. A driving passage 20a is provided through the driver guide 21 and contact top 22 in the front-rear direction. A driving member n supplied in the driving passage 20a is driven by the driver 15. The driven member is ejected from the tip portion (ejection port 22a) of the contact top 22.

The tip portion 22f (ejection port 22a) of the contact top 22 is expanded into a slightly larger-diameter trumpet shape. Accordingly, an inner circumferential space of the tip portion 22f of the contact top 22 is expanded. The inner space functions as a clearance space for the collated strip s of the connected driving members n after driving. The clearance space is enlarged so that the driving member n can be driven in to a predetermined depth without resistance.

### <Retention Mechanism of the Contact Top>

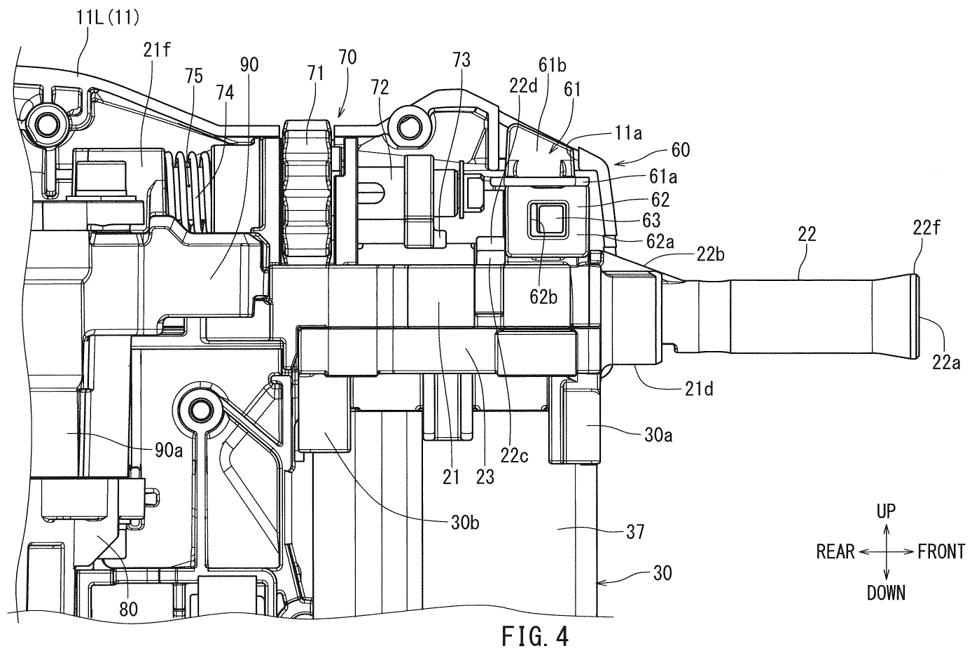

The contact top 22 is configured to be removable from the driver guide 21. As shown in FIGS. 4-7, a retention mechanism 60 is provided in the tip portion of the nose portion 20 to prevent the contact top 22 from slipping out of the driver guide 21. The retention mechanism 60 is provided on the upper surface side of the nose portion 20. A magazine 30 is coupled to the lower surface side of the nose portion 20 (a side opposite to the retention mechanism 60).

The retention mechanism 60 has an operation member 61. The operation member 61 has a rectangular flat plate portion 61a and a knob 61b. The knob 61b is integrally formed with the flat plate 61a, so as to rise upward from the center of the left and right sides of the flat plate 61a. The knob 61b protrudes into an operation recess 11a in the main body housing 11. A user can grasp the knob 61b to move it in the left-right direction.

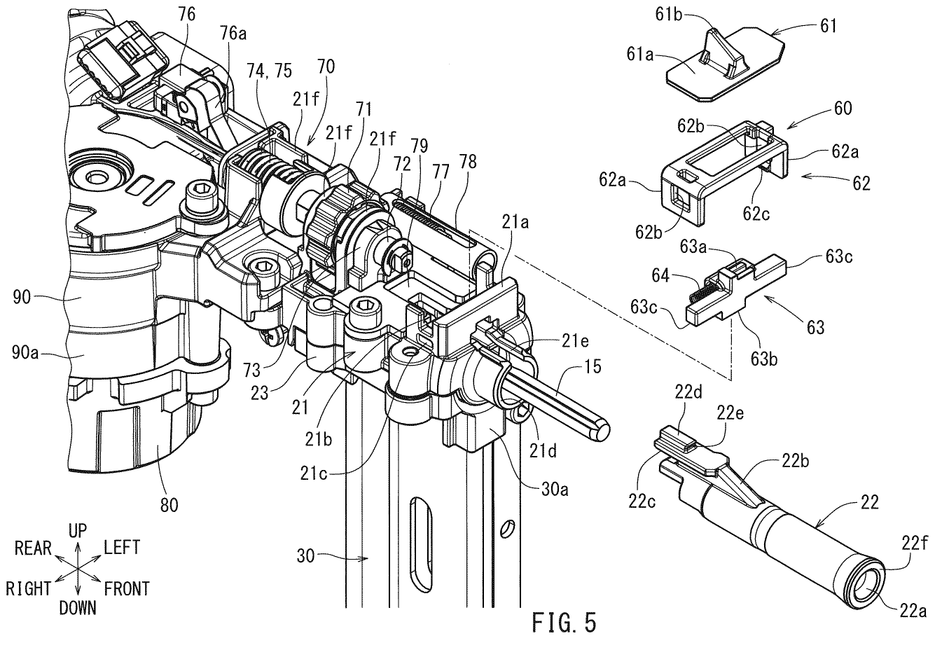

The operation member 61 is supported on the upper surface of the slide base 62. Legs 62a are provided protruding downward at the right and left end portions of the slide base 62. A support base portion 21a is provided on the upper surface of the driver guide 21. The slide base 62 is supported by being placed on the support base portion 21a. Each of the left and right leg 62a is provided with a rectangular support hole 62b. An engagement projection portion 62c is provided below the left and right support holes 62b, respectively. The left and right engagement portions 62c are provided facing each other. In FIG. 5, the right side engagement projection 62c is not visible.

The support base portion 21a of the driver guide 21 is provided with a pair of recesses 21b on the left and right sides. A rectangular engaging recess 21c is provided below the right and left recesses 21b, respectively. The left and right engaging recesses 62c of the slide base 62 engage the engaging recesses 21c of the support base portion 21a, respectively. Accordingly, the slide base 62 is unmovably supported on the upper surface of the support base portion 21a.

A lock member 63 is supported on the slide base 62 so as to be slidable in the left-right direction. The lock member 63 has rectangular prism-shaped arms 63c extending in the left-right direction. The left and right arms 63c are respectively inserted into the support holes 62b of the slide base 62, and the lock member 63 is supported across the left and right legs 62a of the slide base 62 so as to be movable in the left-right direction. An engagement portion 63a is provided at the top of the lock member 63. The engagement portion 63a engages the lower surface of the operation member 61. Due to this configuration, the lock member 63 is displaced in the left-right direction by operating the operation member 61.

A retention portion 63b is provided on the lower surface of the lock member 63. The retention portion 63b protrudes downward. A lock surface 63d is provided on the rear surface of the retention portion 63b. The lock surface 63d is inclined both in the driving direction and a direction perpendicular to the driving direction in the up-down direction. Therefore, the lock surface 63d is inclined downward toward the rear.

A compression spring 64 is interposed between the lock member 63 and the slide base 62. The compression spring 64 biases the lock member 63 leftward toward a locked position. When the lock member 63 is in the locked position, the retention portion 63b is positioned approximately at the center between the left and right legs 62a of the slide base 62. When the lock member 63 is positioned in the locked position, the contact top 22 is prevented from being detached from the driver guide 21. When the operation member 61 is operated to the right against the compression spring 64, the retention portion 63b moves to the right toward the unlocked position. This allows the contact top 22 to be detached from the driver guide 21.

As shown in FIGS. 4 and 5, an anti-rotation portion 22b is provided at the rear of the contact top 22. A circular receiving opening 21d is provided at the front of the driver guide 21. A groove 21e is provided at the top of the receiving opening 21d. The contact top 22 is inserted into an inner circumference of the receiving opening 21d. The anti-rotation portion 22b is inserted into the groove 21e of the receiving opening 21d to prevent rotation of the contact top 22.

A flat-plate-shaped base portion 22c is provided above the anti-rotation portion 22b of the contact top 22. A stopper 22d is provided on the upper surface of the base portion 22c. A stopper surface 22e is provided on the front surface of the stopper 22d. The stopper surface 22e is inclined both in the driving direction and a direction perpendicular to the driving direction in the up-down direction. Therefore, the stopper surface 22e is inclined downward toward the rear. Accordingly, the stopper surface 22e on the contact top 22 side and the lock surface 63d on the nose portion 20 side are mutually parallel to each other. When the stopper surface 22e of the stopper portion 22d contacts the lock surface 63d of the lock member 63, a forward end position of the contact top 22 is restricted and the contact top 22 is retained relative to the driver guide 21.

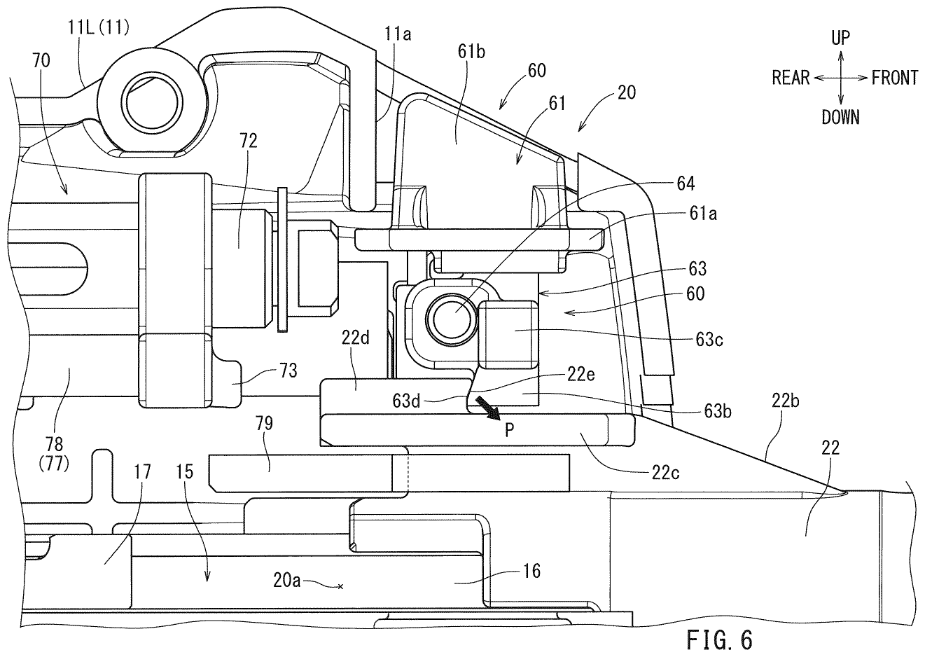

As shown in FIG. 6, at the forward end portion of the contact top 22, the stopper surface 22e of the stopper portion 22d contacts the lock surface 63d of the lock member 63 from above. The stopper surface 22e and lock surface 63d, both of which are inclined downward toward the rear, are brought into contact with each other, thereby restricting the forward end position of the contact top 22. As a result, the impact during driving is received by the retention mechanism 60 via the lock member 63 at the forward end position of the contact top 22. The impact at the time of driving acts on the lock member 63 as an external force P in the direction of pulling the retention mechanism 60 downward. This prevents displacement of the retention mechanism 60, including the lock member 63, in the direction away from the contact top 22. This reduces damage to the retention mechanism 60 and its surrounding area, thereby enhancing the durability of the retention mechanism 60 and its surrounding area.

The contact top 22 of the nose portion 20 is displaceable relative to the driver guide 21 in the front-rear direction within a certain range. When the contact top 22 is brought into contact with the workpiece W and the driving tool 1 is pressed in the driving direction, the contact top 22 is retracted (on operation) relative to the driver guide 21. When the contact top 22 is retracted to the ON position, a rear end portion of an adjustment shaft 72 pushes a detection member 76a to turn on a contact sensor 76. In this manner, when the contact top 22 is on operated and also the switch lever 6 is pulled, a driving operation is performed. This prevents an unintentional driving operation.

An amount of displacement of the contact top 22 can be adjusted (increased or decreased) by rotating the adjustment dial 71 of the adjustment mechanism 70. By adjusting the amount of displacement of the contact top 22, a driving depth of the driving member n into the workpiece W can be adjusted. The adjustment mechanism 70 is provided behind the retention mechanism 60. The adjustment mechanism 70 has an adjustment shaft 72 whose length is changed by changing an engagement position of a screw by rotating an adjustment dial 71. The adjustment shaft 72 extends in the front-rear direction and is supported so as to be movable in the front-rear direction, via a support portion 21f provided on the upper surface of the driver guide 21.

A stopper 73 is provided at the front of the adjustment shaft 72. The stopper 73 protrudes forward behind the stopper 22d of the contact top 22. The contact top 22 is retracted with a rear portion of the stopper 22d in contact with the stopper 73.

The position of the stopper 73 is displaceable in the front-rear direction by rotating the adjustment dial 71. Accordingly, a retracted distance of the contact top 22 relative to the driver guide 21 changes, whereby a driving depth of the driving member n into the workpiece W can be adjusted. The adjustment shaft 72 and stopper 73 are biased forward by the first and second springs 74, 75. Therefore, the contact top 22 is retracted against the biasing force of the first and second springs 74, 75.

The first and second springs 74, 75 are coil springs (compression coil springs) having different diameters and are arranged to overlap in the radial direction. The second spring 75 has a smaller diameter than the first spring 74 and is accommodated on an inner circumferential side of the first spring 74. The winding directions of the first and second springs 74, 75 are opposite to each other. This configuration prevents the first spring 74 and the second spring 75 from becoming entangled.

The first and second springs 74, 75 ensure a sufficiently large biasing force in the forward direction for the adjustment shaft 72 and stopper 73. This configuration allows the contact top 22 to be moved rearward against the sufficiently large biasing force. The necessary force to resist the movement of the contact top 22 is shared between the first and second springs 74, 75. This allows the use of springs with thinner linear springs compared to a configuration in which a single large spring provides a force equivalent to the combined force of the first and second springs 74, 75, thereby improving spring durability. When the contact top 22 is moved to its retracted end, the rear end of the adjustment shaft 72 pushes the detection member 76a to actuate the contact sensor 76.

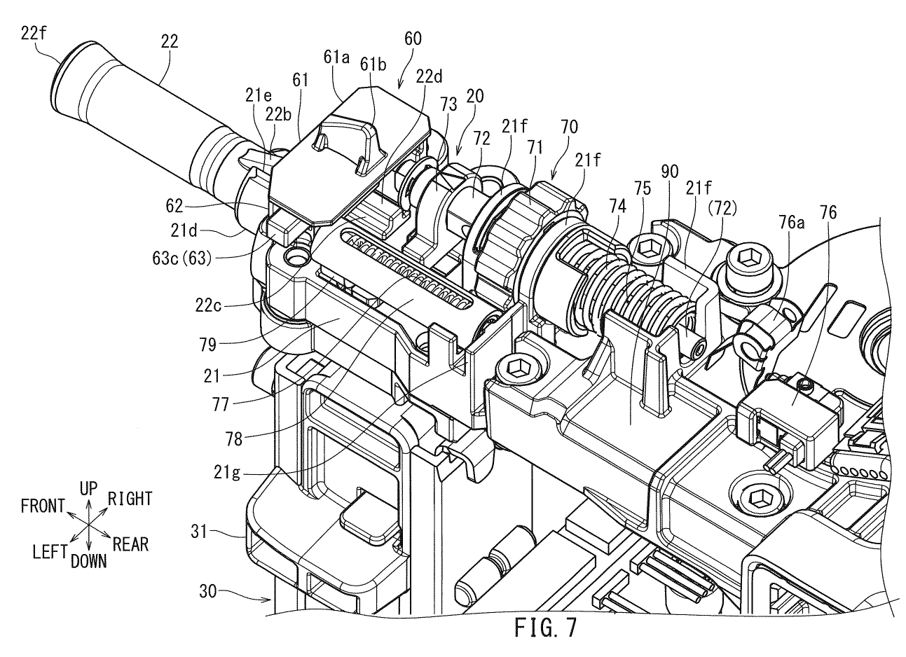

An actuation plate 79 is provided on the upper surface of the driver guide 21, so as to be movable in the front-rear direction. As shown in FIGS. 5 and 7, a third spring 77 is provided on the upper surface of the driver guide 21. The third spring 77 is held inside a tubular housing 78. An actuation plate 79 is in contact with a front end of the third spring 77. A rear end of the third spring 77 contacts a wall portion 21g in the driver guide 21. Due to this configuration, the contact top 22 is also biased forward toward the off position by the biasing force of the third spring 77 via the actuation plate 79.

The contact top 22 is operated to move rearward to the on position against the biasing forces of the first spring 74, second spring 75 and third spring 77. In other words, the contact top 22 is returned forward to the off position by the biasing forces of the three springs 74, 75, and 77.

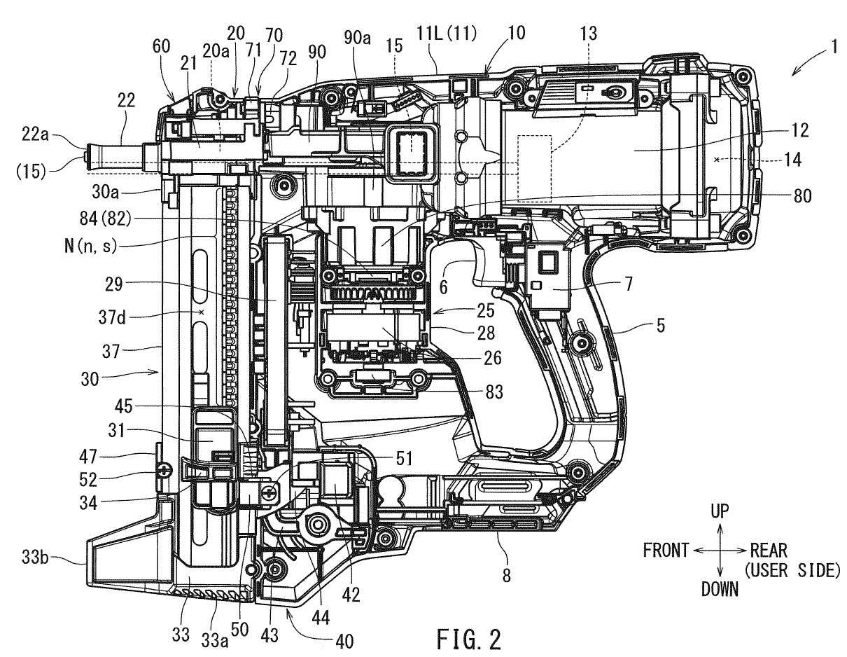

As shown in FIG. 2, a rear portion of the cylinder 12 behind the piston 13 connects to an accumulation chamber 14. The accumulation chamber 14 is filled with compressed gas, such as air. The gas pressure in the accumulation chamber 14 acts on the rear surface of the piston 13 as a thrust force to move the piston 13 forward in the driving direction. After moving forward in the driving direction owing to the gas pressure, the piston 13 and driver 15 return rearward to the standby position by the lift mechanism 25.

### <Spigot Joint of the Bearing Holder>

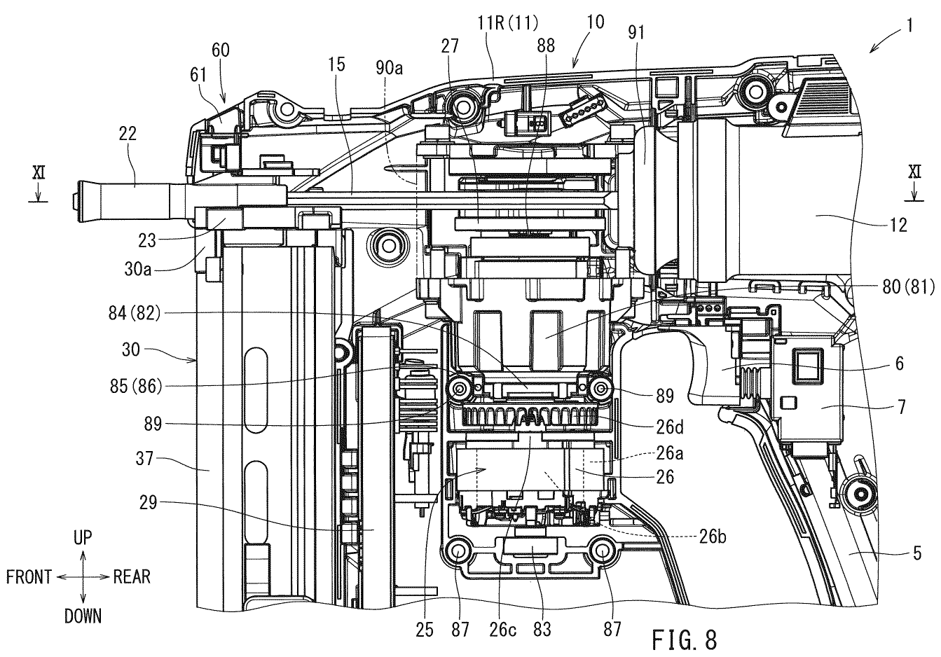

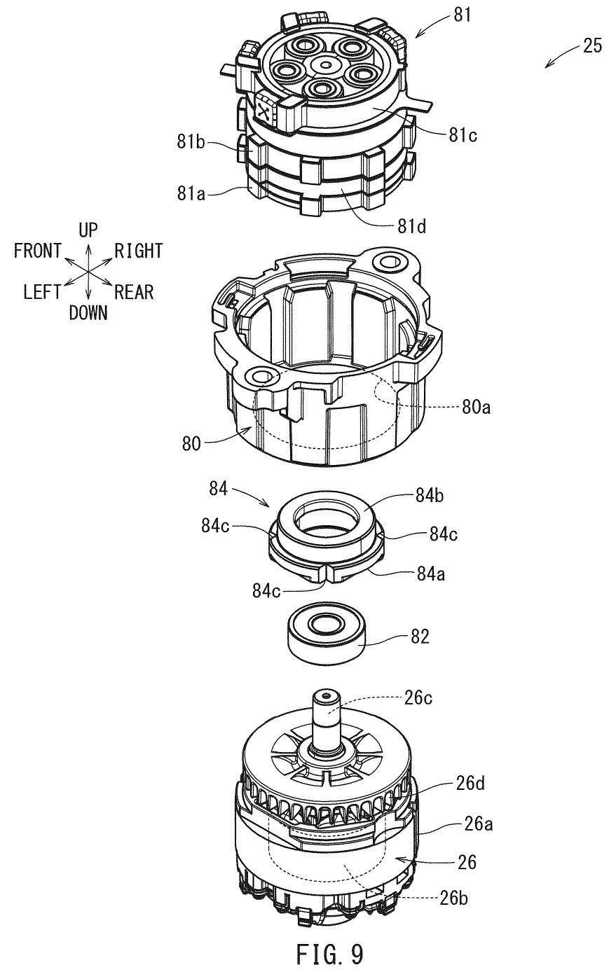

As shown in FIGS. 8 and 9, the lift mechanism 25 is located extending downward from the front of the tool main body 10. The lift mechanism 25 has an electric motor 26, a reduction gear train 81 that reduces the output of the electric motor 26, and a lifter 27 that is connected to the output side of the reduction gear train 81 and rotated by the rotational output of the electric motor 26. The motor shaft axis of the electric motor 26 and the rotation shaft axis of the lifter 27 are coaxial with each other and perpendicular to the moving direction (front-rear direction) of the driver 15.

The electric motor 26 has a stator 26a and a rotor 26b. The stator 26a is fixed directly to the inner surface of the main body housing 11. The rotor 26b is supported on the inner circumference of the stator 26a. The rotor 26b is supported by the motor shaft 26c. A lower portion (first portion) of the motor shaft 26c is rotatably supported by the main body housing 11 via a first bearing 83. A cooling fan 26d is supported on the upper portion of the motor shaft 26c. Above the cooling fan 26d, the upper portion (second portion) of the motor shaft 26c is rotatably supported by the gear housing 80 via a second bearing 82.

The second bearing 82 located on an upper side is supported at the bottom of the gear housing 80 via a bearing holder 84. The bearing holder 84 has a first annular portion 84a and a second annular portion 84b whose diameter is smaller than the first annular portion 84a. The bearing holder 84 is formed of a single member having the first annular portion 84a and the second annular portion 84b. The second bearing 82 is held on the inner circumference of the second annular portion 84b. The first annular portion 84a is supported by the main body housing 11, and the second annular portion 84b is supported by the opening 80a on the lower side of the gear housing 80. The opening 80a is formed as a circular opening. The second annular portion 84b is fitted (lightly press-fitted, or spigot joint) into the opening 80a of the gear housing 80 without rattling.

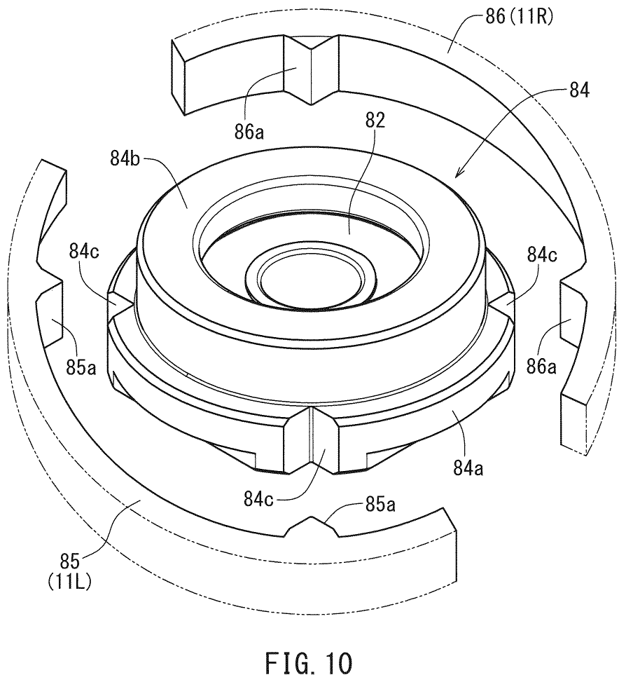

Four V-shaped recess (anti-rotation portion 84c) are provided at equally spaced positions on the outer circumferential surface of the first annular portion 84a. The inner surfaces of the left-right half-split housings 11L and 11R of the main body housing 11 are respectively provided with holder receiving portions 85 and 86 formed in a semicircular configuration (refer to FIG. 10). The inner surfaces of the left and right holder receiving portions 85, 86 are provided with two engagement projection 85a, 86a, respectively. Each of the four engagement projections 85a, 86a has a V-shaped protrusion that is engageable with the anti-rotation portion 84c.

The first annular portion 84a is supported by being clamped between the holder receiving portions 85, 86 of the main body housing 11. The bearing holder 84 is prevented from rotating by engagement of the four engagement projection 85a, 86a on the main body housing 11 with the four anti-rotation portions 84c of the first annular portion 84a. The second annular portion 84b is supported by the gear housing 80, and the first annular portion 84a is supported by the main body housing 11. This makes it possible to omit the motor housing to reduce the weight of the driving tool 1, while suppressing misalignment of the motor shaft 26c, thereby reducing contact between the rotor 26b and the stator 26a (core rubbing).

As shown in FIG. 8, the left-right half-split housings 11L, 11R are fastened together with screws at two positions on the outer circumferential side of the holder receiving portions 85, 86. In other words, second fixing elements (screws) 89, which fasten the right and left half-split housings 11L, 11R to each other, are located on the upper second plane that includes the second bearing 82 and is perpendicular to the motor shaft 26c. Furthermore, first fixing elements (screws) 87, which fasten the right and left half-split housings 11L, 11R to each other, are located on the lower first plane that includes the first bearing 83 and is perpendicular to the motor shaft 26c.

The gear housing 80 has a tubular shape and surrounds the reduction gear train 81. Three-stage planetary gear 81a, 81b, 81c are used in the reduction gear train 81. A one-way clutch 81d is interposed between the first-stage planetary gear 81a and the second-stage planetary gear 81b. The one-way clutch 81d protects the electric motor 26 against an impact added to the lifter 27 in a direction opposite to a lifting direction.

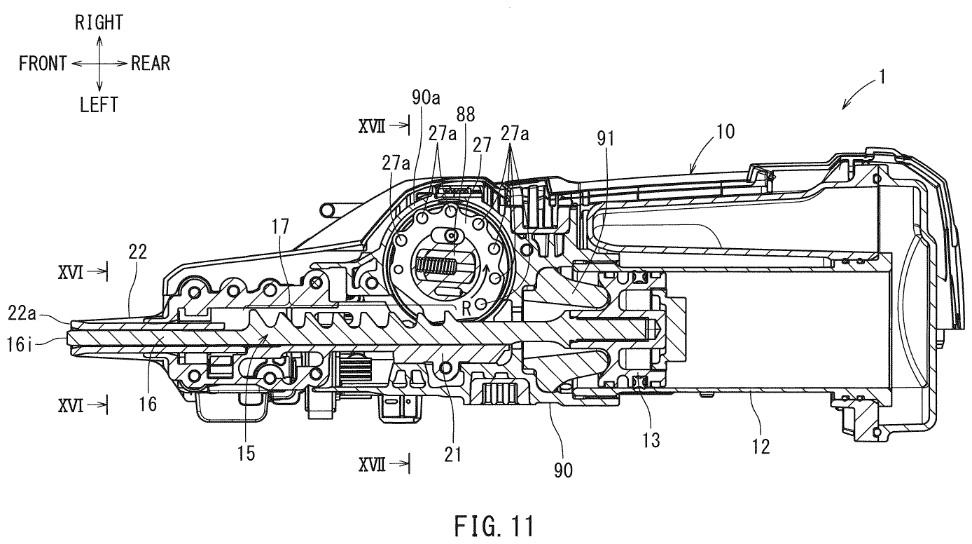

As shown in FIGS. 2, 3, and 11, the gear housing 80 is coupled to a tubular mechanism case 90a. The mechanism case 90a is integrally provided to the lower surface of the lifter base 90. The lifter base 90 is coupled to the front of the cylinder 12. Between the lifter base 90 and the front of the cylinder 12, a damper 91 is disposed to absorb an impact at the lower moving end of the piston 13 (refer to FIG. 8). The driver guide 21 is arranged in the front of the lifter base 90. A lifter shaft 88 is coupled to the output side of the reduction gear train 81. A lifter 27 is supported by the lifter shaft 88. When the electric motor 26 is activated, the lifter 27 rotates in the direction indicated by an arrow R in FIG. 11.

As shown in FIG. 11, the lifter 27 has a plurality of engaging portions 27a. In FIG. 11, eight engaging portions 27a are shown. Each engaging portion 27a has a cylindrical shape having a circular cross section. The plurality of engaging portions 27a are arranged parallel to the lifter shaft 88 at approximately equal intervals in a fixed area around the axis of the lifter shaft 88.

### <Durability of the Driver>

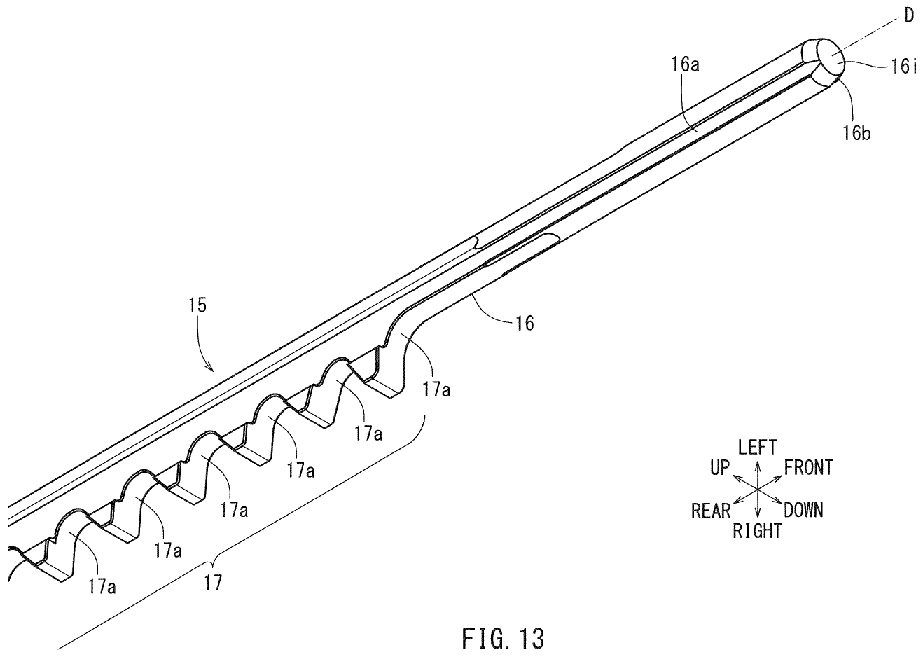

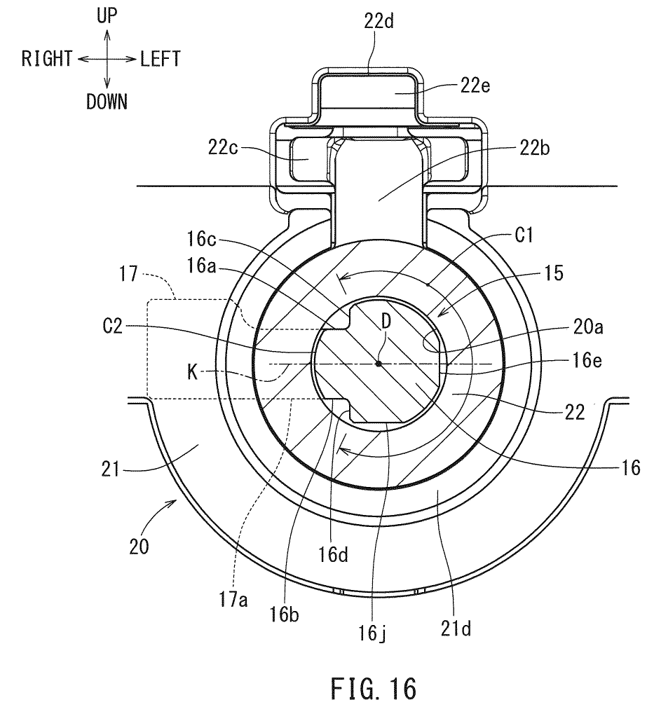

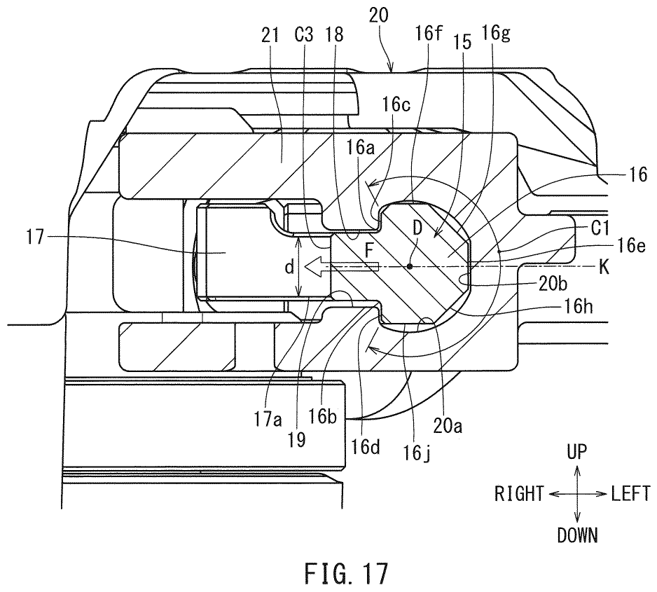

As shown in FIGS. 11-13, driver 15 has a long bar shape extending in the front-rear direction. The driver 15 has a driver main body 16 extending in the driving direction and a plurality of rack teeth 17 protruding from the driver main body 16 in a radial direction of the lifter 27. A tip portion 16i of the driver main body 16 strikes (drives) a head of the driving member n. The driver main body 16 has a substantially circular rod-like shape in cross section around the driving axis D, corresponding to the head of the driving member n (e.g., circular). A plurality of rack teeth 17 are arranged in a row along the longitudinal direction of the driver main body 16 and formed integrally therewith. In FIGS. 16 and 17, eight rack teeth 17 are shown.

Each rack tooth 17 protrudes from the driver main body 16 toward the right side (toward the lifter 27). After the piston 13 has reached the forward end by the driving operation, the lifter 27 rotates counterclockwise (in the direction indicated by the arrow R in FIG. 11). Because of this movement, a first engaging portion 27a of the lifter 27 in the rotation direction engages a rearmost rack tooth 17. As the lifter 27 rotates in the direction of the arrow R, the plurality of engaging portions 27a of the lifter 27 successively engage the rack teeth 17. This returns the driver 15 to the standby position at the rear. In the standby position, the electric motor 26 starts and the driver 15 moves rearward from the standby position, thereby disengaging the lifter 27 from the driver 15. As a result, the driver 15 moves forward to perform the driving operation.

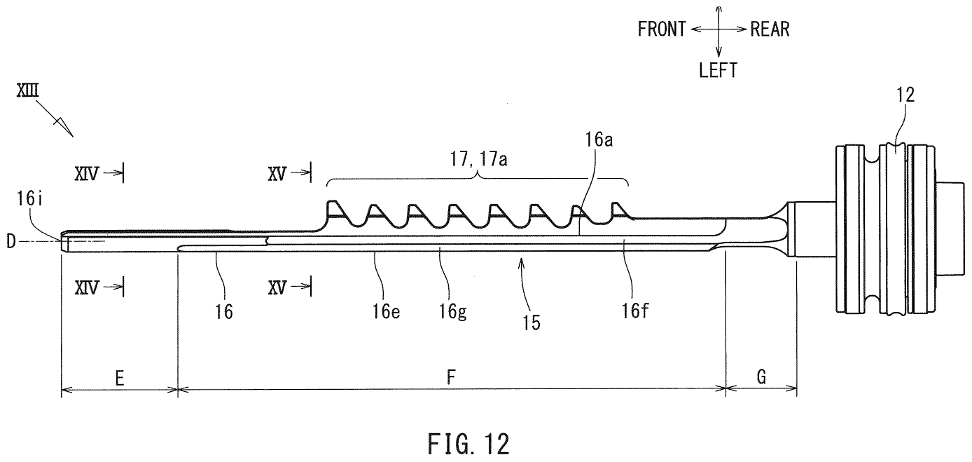

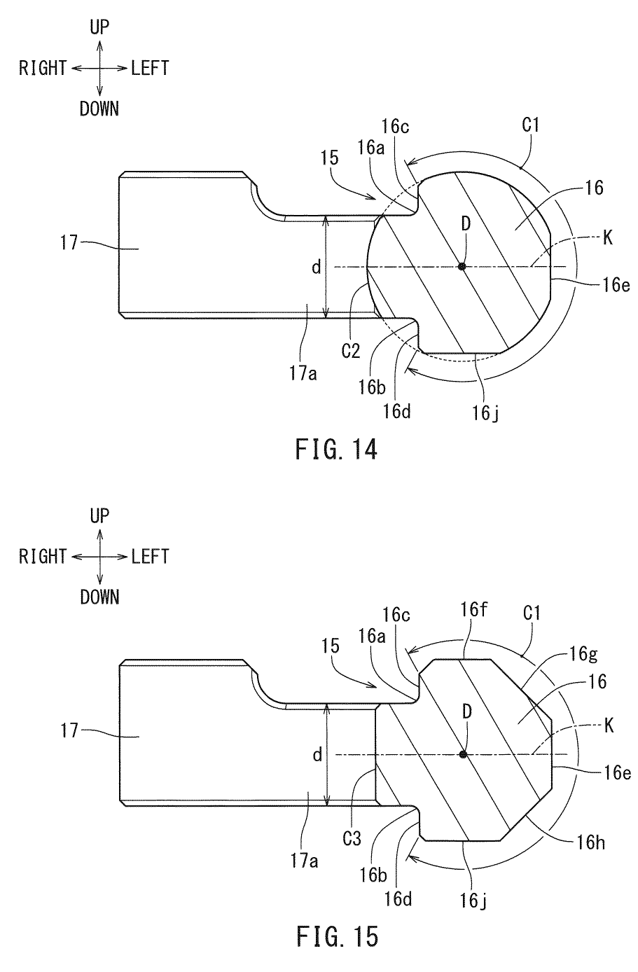

As shown in FIGS. 12-16, the right side of the driver main body 16 (on the side of the rack teeth 17) is provided with a first recess 16a and a second recess 16b. Both the first recess 16a and the second recess 16b are provided on the rack tooth 17 side with respect to the driving axis D of the driver main body 16. As shown in FIGS. 14-17, the first recess 16a and the second recess 16b each have an L-shaped bent cross section, and are arranged in positions and shapes symmetrical to a virtual plane K that passes through the center of the driver main body 16 (driving axis D) and includes the protruding direction of the rack teeth 17. Accordingly, the first recess 16a are provided symmetrically above and below the base portion 17a of the rack teeth 17 with respect to the virtual plane K.

The first recess 16a and the second recess 16b are provided along the right side of the driver main body 16, extending over almost the entire longitudinal region from near the piston 13 to the tip portion 16i. As shown in FIGS. 14 and 15, the first recess 16a and the second recess 16b are arranged in the up-down direction at intervals approximately equal to the thickness d of the rack teeth 17. The first recess 16a and the second recess 16b have bottom surfaces 16c and 16d, respectively, which extend perpendicular to a direction in which the rack teeth 17 extend. The bottom surfaces 16c and 16d restrict the displacement of the driver main body 16 toward the rack teeth 17.

A first guide 18 and a second guide 19 are provided in the driving passage 20a of the driver guide 21 (refer to FIG. 17). The first guide 18 and the second guide 19 each have a rectangular corner shape and protrude into the driving passage 20a. The first guide 18 and the second guide 19 protrude into the first recess 16a and the second recess 16b of the driver 15, respectively. The first guide 18 and second guide 19 guide the driver 15 in the driving direction.

The first guide 18 of the driver guide 21 enters the first recess 16a at an upper portion of the driver 15 and the second guide 19 of the driver guide 21 enters the second recess 16b at a lower portion, so as to restrict rotation of the driver 15 about the driving axis D and displacement toward the rack teeth 17.

The cross-sectional shape of the driver main body 16 is generally circular about the driving axis D, except for portions corresponding to the first guide 18 and the second guide 19. As shown in FIG. 12, the driver 15 is divided into three regions along the longitudinal direction from the tip portion 16i of the driver body 16 to a vicinity of the piston 13: region E on the tip side, region F including the rack teeth 17, and region G on the piston 13 side. The cross-sectional shape of a left half portion of the driver body 16 differs among regions E, F, and G.

As shown in FIGS. 14-17, a flat lower surface 16j is provided on the lower surface of the driver main body 16 and a flat surface 16e on the right side in the region E on the tip side and the region F on a center side. The flat lower surface 16j and the flat surface 16e extend over the entire regions E and F in the longitudinal direction. As shown in FIGS. 15 and 17, a flat upper surface 16f and upper and lower inclined rear surfaces 16g and 16h are provided in the F region, in addition to the lower surface 16j and the flat surface 16e. The upper surface 16f and the upper and lower inclined rear surfaces 16g and 16h also extend over the entire region F in the longitudinal direction.

As shown in FIGS. 14 and 16, in the E region, the driver main body 16 has a cross-sectional shape that is substantially circular about the driving axis D, except for the first recess 16a and the second recess 16b and except for the lower surface 16j and the flat surface 16e in a C1 area. A C2 area between the first recess 16a and the second recess 16b has an arc shape about the driving axis D. In the E region, the cross-sectional shape is formed of three circumferential arc surfaces in the C1 and C2 areas, each having the same diameter about the driving axis D. In the C1 area, the first recess 16a and the second recess 16b are positioned on the rack tooth 17 side such that the C1 area extends over more than 180 degrees about the driving axis D.

As shown in FIGS. 15 and 17, in the F region, the driver main body 16 has a cross-sectional shape that forms a polygonal shape including the lower surface 16j, the flat surface 16e, the upper surface 16f, and the upper and lower inclined rear surfaces 16g and 16h in the C1 area on the left side (rear side), excluding the first recess 16a and the second recess 16b. In the F region, a flat surface is provided between the recesses 16a and 16b in the C3 area.

As shown in FIGS. 14 and 16, in the E region, the C1 area on the rear side and the C2 area on the rack tooth side are guided by the circular driving passage 20a. Accordingly, in the C1 and C2 areas in the E region, rotation of the driver main body 16 about the driving axis D is not restricted. Furthermore, the inner circumferential surface of the contact top 22 is not provided with any portion for restricting rotation of the driver main body 16, in order to allow smooth passage of the driving member n. When the driver 15 is returned to an upper standby position, the first guide 18 enters the first recess 16a and the second guide 19 enters the second recess 16b, thereby restricting rotation of the driver main body 16 in both directions about the driving axis D and preventing displacement toward the rack tooth 17 side.

As shown in FIG. 17, a flat guide surface 20b is provided on the left side of the driving passage 20a. In the F region, the flat surface 16e faces the guide surface 20b at a sufficiently close distance, thereby restricting rotation of the driver main body 16 about the driving axis D. Except for the guide surface 20b, a portion of the driving passage 20a opposite the C1 area (inner side of the contact top 22) has a circular shape. In the F region, the first guide 18 enters the first recess 16a and the second guide 19 enters the second recess 16b, thereby restricting rotation of the driver main body 16 in both directions about the driving axis D and reliably preventing displacement toward the rack tooth 17 side.

The engaging portion 27a of the lifter 27 engages each rack tooth 17 from the front, and the driver 15 is returned rearward. When the engaging portion 27a engages a front surface of the rack tooth 17, a pulling force F is applied to the rack tooth 17 in a direction toward the lifter 27, caused by friction with the engaging portion 27a. The pulling force F acts as an external force to rotate the driver 15 about the driving axis D and displace it toward the rack teeth 17. If the rotation of the driver 15 about the driving axis D and the displacement toward the rack teeth 17 are not sufficiently restricted, the rack teeth 17 may tilt in the up-down direction, resulting in uneven contact with the engaging portion 27a, which can lead to stress concentration on the base portion 17a of the rack teeth 17.

In this embodiment, in the F region where the lifter 27 engages each rack tooth 17 of the driver 15, the first guide 18 enters the first recess 16a on the upper side of the base portion 17a of the rack tooth 17, and the second guide 19 enters the second recess 16b on the lower side of the base portion 17a of the rack tooth 17. As a result, the rotation of the driver main body 16 about the driving axis D is restricted, and the displacement of the driver body 16 toward the rack teeth 17 is reliably restricted. This suppresses stress concentration on the driver 15 and improves its durability.

As described above, the cross-sectional shape of the driver main body 16 has a polygon that is inscribed in or follows a substantially circular shape over at least a 180° range (C1 region) around the driving axis D. Accordingly, when the driver main body 16 has a cross-sectional shape that is not flat but forms a polygon inscribed in or following a single circular shape over at least a 180° range around the driving axis D, the provision of the first recess 16a and the second recess 16b makes it possible to restrict rotation of the driver main body 16. In a case where the driver main body 16 has a polygonal cross-sectional shape inscribed in or following a single circular shape over at least a 180° range (C1 region) around the driving axis D, and the driver guide 21 has an inner circumferential surface of circular cross-section without a flat surface corresponding to the polygon on the driving passage 20a side of the driver guide 21, omitting either the first recess 16a or the second recess 16b would result in failure to restrict rotation (twisting) of the driver main body 16 in one direction. By providing both the first recess 16a and the second recess 16b, rotation of the driver main body 16 in both directions around the driving axis D is restricted, thereby improving the durability of the driver 15.

As shown in FIGS. 1-3, a grip 5 for a user to grasp is provided behind the lift mechanism 25. The grip 5 extends downward from a side portion of the tool main body 10. A switch lever 6 is provided on the upper front surface of the grip 5, which is operated by the user by pulling it with a fingertip. When the switch lever 6 is pulled, the switch main body 7 is turned on and the electric motor 26 of the lift mechanism 25 is activated.

A rectangular flat-plate-shaped controller 29 is located in front of the lift mechanism 25 and the electric motor 26. The controller 29 is arranged so as to extend in the up-down direction. The lift mechanism 25, the electric motor 26, and the controller 29 are housed in a generally tubular lift housing 28.

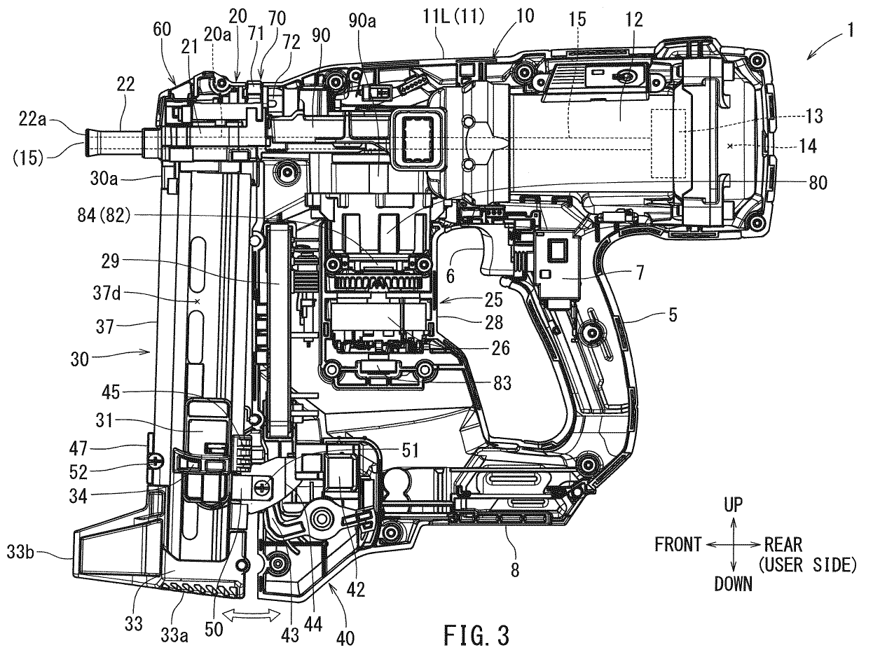

A battery attachment portion 8 is provided at the bottom of the grip 5. As shown in FIG. 1, a single battery pack 9 is mounted on the lower surface of the battery attachment portion 8. The battery pack 9 can be attached to and removed from the battery attachment portion 8 by sliding it in the front-rear direction. FIGS. 2 and 3 show the battery pack 9 removed from the battery attachment portion 8.

A hook 2 is provided on the left side of the front portion of the battery attachment portion 8. By hooking the hook 2 onto the user's waist belt or similar, the driving tool 1 can be hung from the waist belt when not in use.

The front portion of the battery attachment portion 8 connects to the lower portion of the lift housing 28. The main body housing 11, the lift housing 28, the battery attachment portion 8, and the grip 5 are interconnected in a loop shape and integrally formed, each having a left-right half-split structure.

### <Removable Magazine>

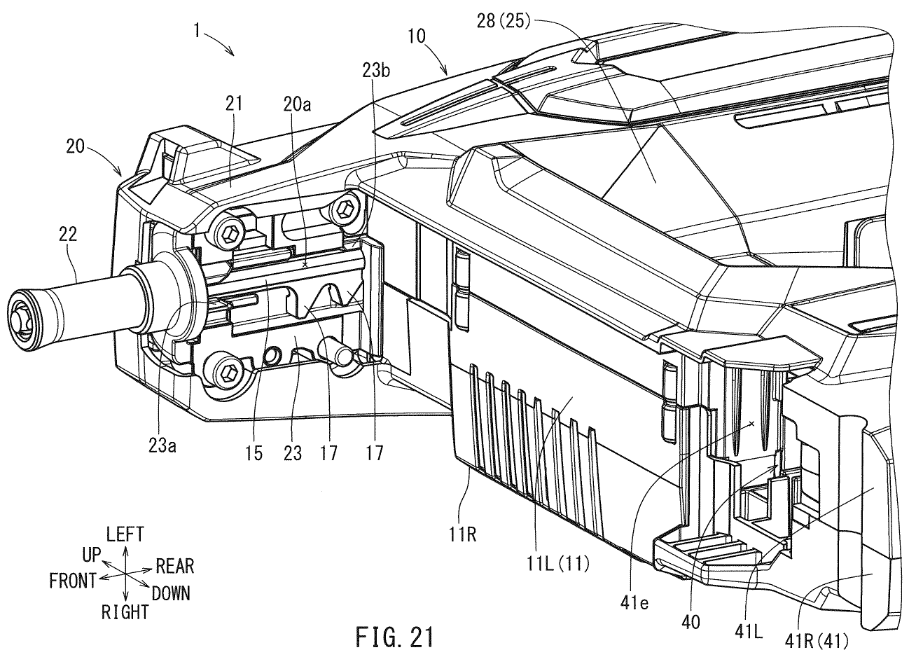

As shown in FIGS. 1-3, the driving tool 1 is equipped with a detachable magazine 30. The magazine 30 is removably mounted on the lower surface of the nose portion 20 and along the front of the lift mechanism 25. The magazine 30 has a magazine main body 37 made of pultruded aluminum. The magazine main body 37 has a rectangular shape extending in the up-down direction. The interior of the magazine main body 37 forms a housing portion 37D in which the driving members (driving fasteners) n are accommodated. A top portion of the magazine main body 37 is coupled to a magazine base 23 (refer to FIG. 21). The magazine base 23 is coupled along the lower surface of the driver guide 21. Thus, the magazine 30 is arranged extending downward from the driver guide 21. A plurality of driving members n are loaded into the housing portion 37d of the magazine 30 in the form of connected driving members (fastener assembly) N.

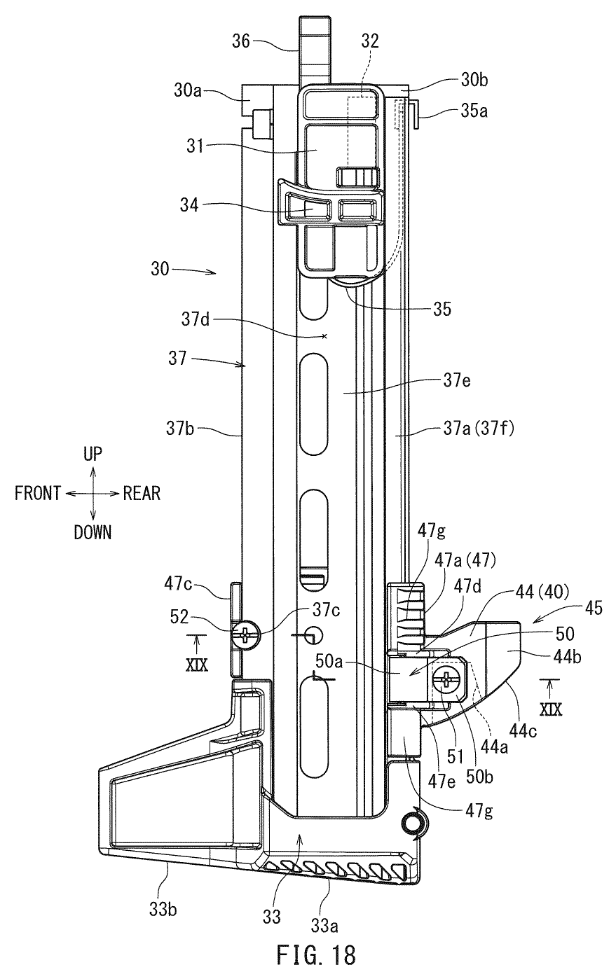

As shown in FIG. 18, the magazine 30 has a pusher 31. The pusher 31 has a feed claw 32, a restriction claw 36, and a coil spring 35. The feed claw 32 engages the rearmost end of the loaded connected driving members N. Accordingly, the connected driving members N is pushed toward the driving passage 20a. When a remaining amount of the driving members n in the magazine 30 becomes low, the restriction claw 36 moves into the rear of the contact top 22. This restricts a rearward movement of the contact top 22, thereby preventing dry firing.

The pusher 31 is biased in the feeding direction (upward) of the driving member n by the coil spring 35. An end portion 35a of the coil spring 35 is hooked onto an upper portion of the magazine main body 37. The loaded connected driving members N are pushed by the pusher 31 toward the driving passage 20a. The driving members n are supplied one by one into the driving passage 20a of the nose portion 20 in conjunction with the driving operation of the tool main body 10.

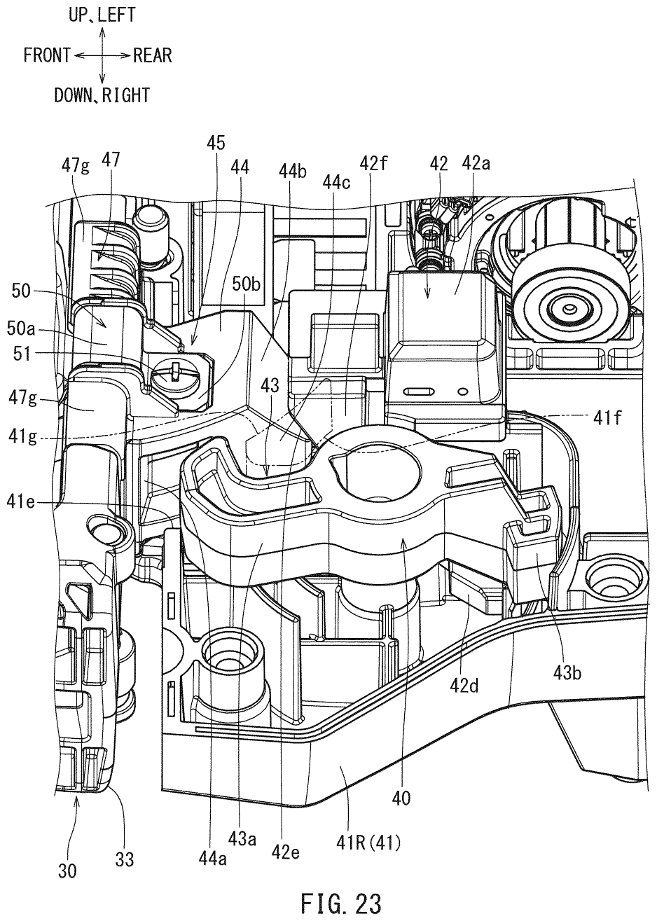

As shown in FIGS. 1-3, 18, and 20, an end plate 33 is attached to the lower portion of the magazine 30. A loading port 33a is provided in the end plate 33 (referring to, especially, FIG. 23). The connected driving members N are loaded into the housing portion 37d of the magazine main body 37 via the loading port 33a. The pusher 31 is provided with a knob 34. When loading the connected fastener assembly N, the knob portion 34 is first gripped, and the pusher 31 is moved downward (rearward in the feed direction) against the coil spring 35. During the downward movement of the pusher 31, the feed claw 32 disengages from its engagement position with the connected driving members N. Once the pusher 31 is moved downward from the connected driving members N, the feed claw 32 engages the rearmost end of the connected driving members N. This pushes the loaded connected driving members N toward the driving passage 20a of the nose portion 20.

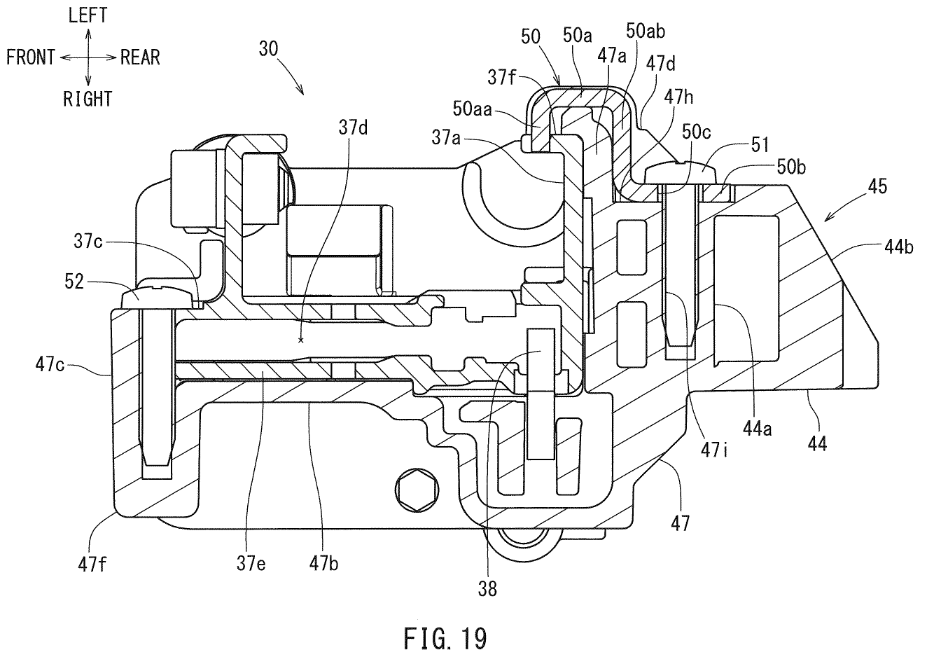

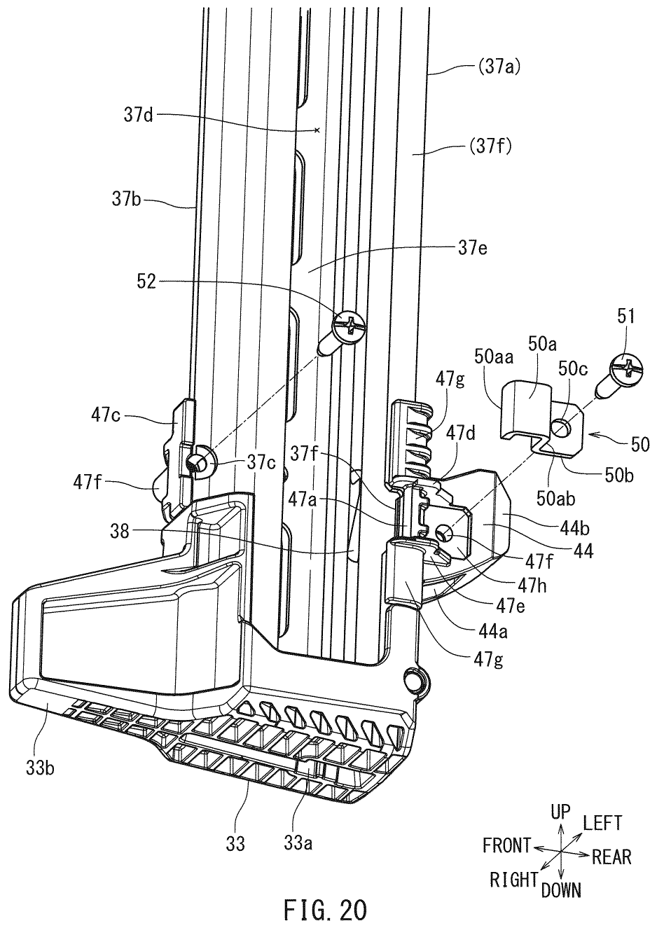

As shown in FIGS. 19 and 20, the housing portion 37d of the magazine main body 37 is provided with a stopper 38 to prevent the loaded connected driving members n from accidentally coming out through the loading port 33a. The end plate 33 is provided with a contact portion 33b that protrudes forward. By bringing the contact portion 33b into contact with the workpiece W during the driving work, the driving tool 1 can be held in a stable posture. This facilitates the driving operation.

The magazine 30 can be detached from the nose portion 20. This facilitates removal of driving members n that have become jammed in the nose portion 20. Front and rear engaging portions 30a and 30b are provided at the upper portion of the magazine 30 (refer to FIG. 18). As shown in FIG. 21, the magazine base 23 is provided with a pair of front and rear magazine receiving portions 23a, 23b. The driving passage 20a is opened between the front and rear magazine receiving portions 23a, 23b. The driving members n are supplied into the driving passage 20a via the front and rear magazine receiving portions 23a and 23b.

The magazine 30 is coupled to the magazine base 23 with the front engaging portion 30a engaging the front magazine receiving portion 23a and the rear engaging portion 30 b engaging the rear magazine receiving portion 23b. When attaching the magazine 30 to the magazine base 23, the entire magazine 30 is rotated rearward around an engaging portion of the front side magazine receiving portion 23a that engages the front engaging portion 30a, as shown by the hollow arrow in FIG. 3. As a result, the rear engaging portion 30b engages the rear magazine receiving portion 23b of the magazine base 23, and the magazine 30 is attached to the attachment position parallel to the lift mechanism 25 (the position shown in FIGS. 1 and 2).

To remove the magazine 30 from the magazine base 23, the entire magazine 30 is rotated forward around the engaging portion of the front side magazine receiving portion 23a that engages the front engaging portion 30a, as shown by the hollow arrow in FIG. 3. This allows the rear engaging portion 30b to detach from the rear magazine receiving portion 23b of the magazine base 23 and move to the removal position shown in FIG. 3. FIG. 3 shows that a lower portion of the magazine 30 is apart from the lift housing 28. The magazine 30 is rotated to the removal position to completely detach the magazine 30 from the magazine base 23.

### <Magazine Lock Portion>

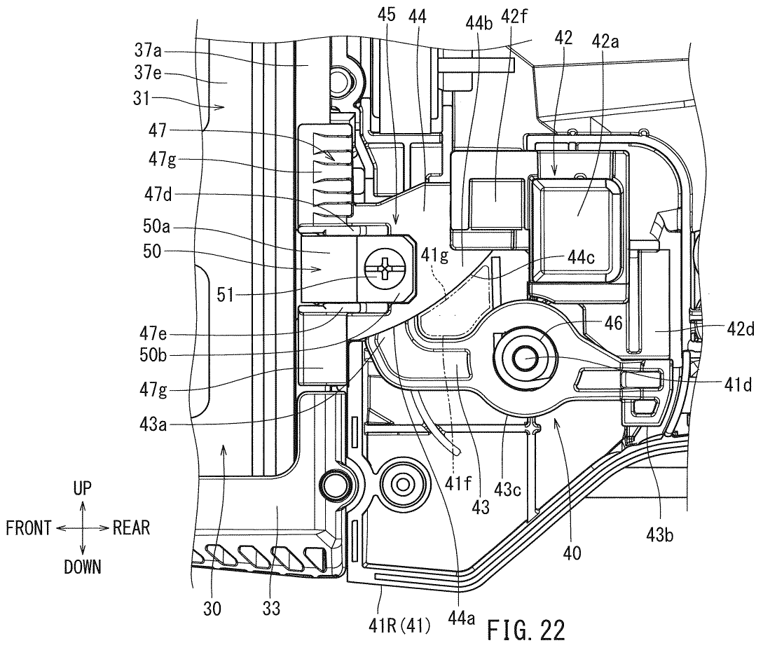

The magazine 30 is secured at its mounting position by the magazine lock portion 40. As shown in FIGS. 22-24, the magazine lock portion 40 has an operation member (actuator) 42 and lock member 43 on the tool main body 10 side and a magazine holder 45 on the magazine 30 side. The operation member 42 and lock member 43 are supported by the lock housing 41. The lock housing 41 is integrally formed with the lower portion of the lift housing 28. The lock housing 41 has a left-right half-split structure, similar to the lift housing 28. In more detail, the lock housing 41 has a half-split structure with a right housing 41R abutted against a left housing 41L. The magazine holder 45 is provided on the lower side of the magazine 30.

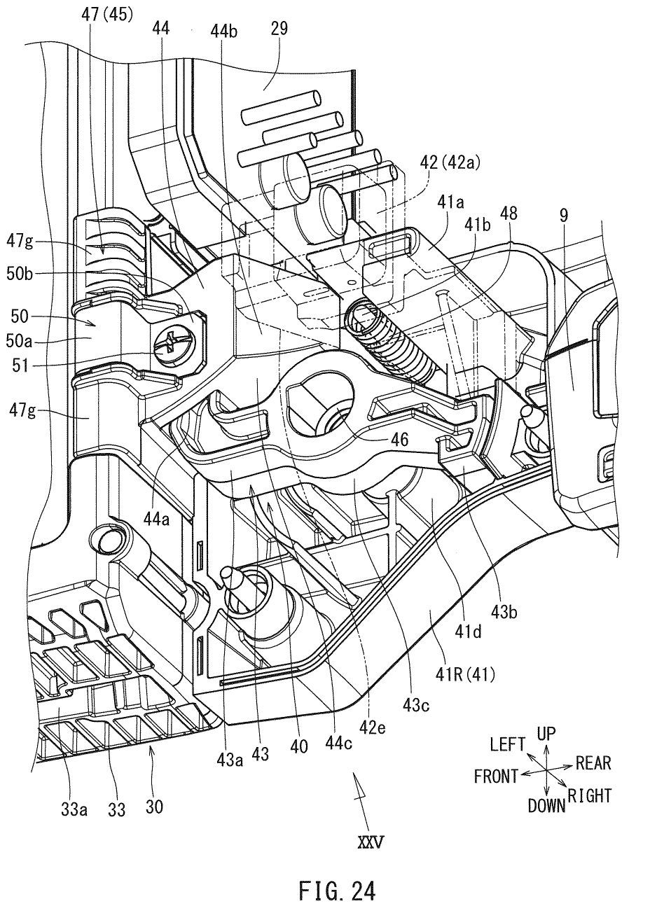

As shown in FIG. 24, the right housing 41R of the lock housing 41 has a support column 41a and a retention post 41b. The support column 41a has a substantially prismatic shape. The retention post 41b has a substantially cylindrical shape. The support column 41a and the retention post 41b are arranged parallel to each other and extend toward the left.

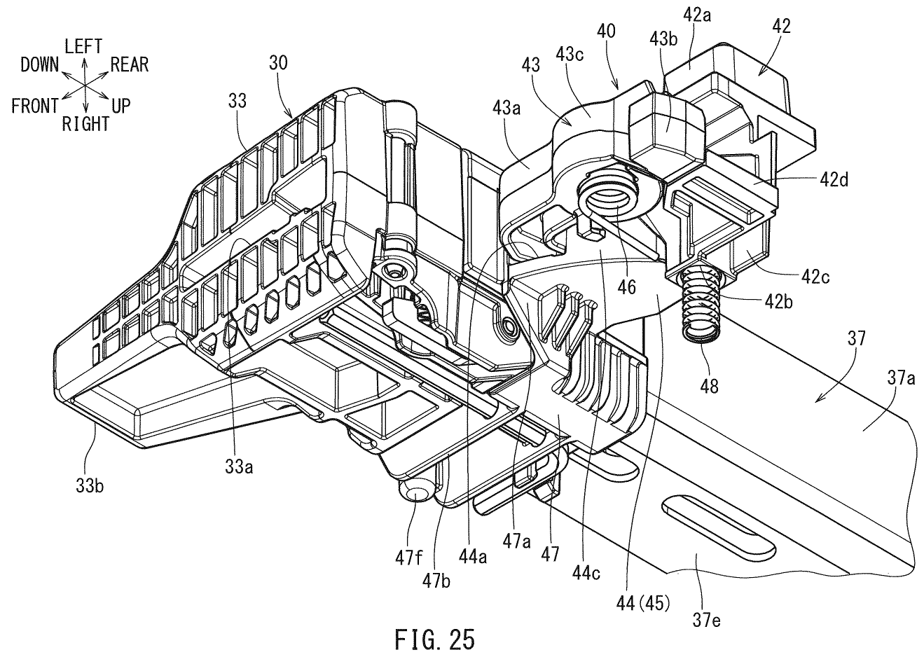

As shown in FIG. 25, a square retention groove 42c and a circular retention hole 42b are provided in the right portion of operation member 42. The support column 41a is positioned in the retention groove 42c and the operation member 42 is movably supported between the locked position on the left side and the unlocked position on the right side. The retention post 41b holds a biasing member 48. A compression spring is used as the biasing member 48. The retention post 41b and the biasing member 48 are held in the retention hole 42b. The biasing member 48 biases the operation member 42 toward the locked position (to the left).

A prism-shaped operation portion 42a is provided on the left side of the operation member 42. As shown in FIG. 1, a rectangular window 41c is provided in the left housing 41L of the lock housing 41. The operation portion 42a of the operation member 42 protrudes through the window 41c to the outside of the lock housing 41. The user can apply a fingertip to the operation portion 42a and push the operation member 42 toward the unlocked position (to the right) against the biasing member 48.

As shown in FIGS. 22 and 25, a stopper 42d is integrally formed on the right portion of the operation member 42. The stopper 42d extends toward the lock member 43. The stopper 42d restricts the lock member 43 from displacing to the unlocked side. Therefore, the lock member 43 does not rotate toward the unlocked side unless the operation portion 42 is pushed toward the unlocked side. Accordingly, even if the magazine 30 is pulled in the removal direction without pushing the operation member 42 toward the unlocking side, the lock state of the magazine 30 at the mounting position is not released because the lock member 43 does not rotate toward the unlocking side.

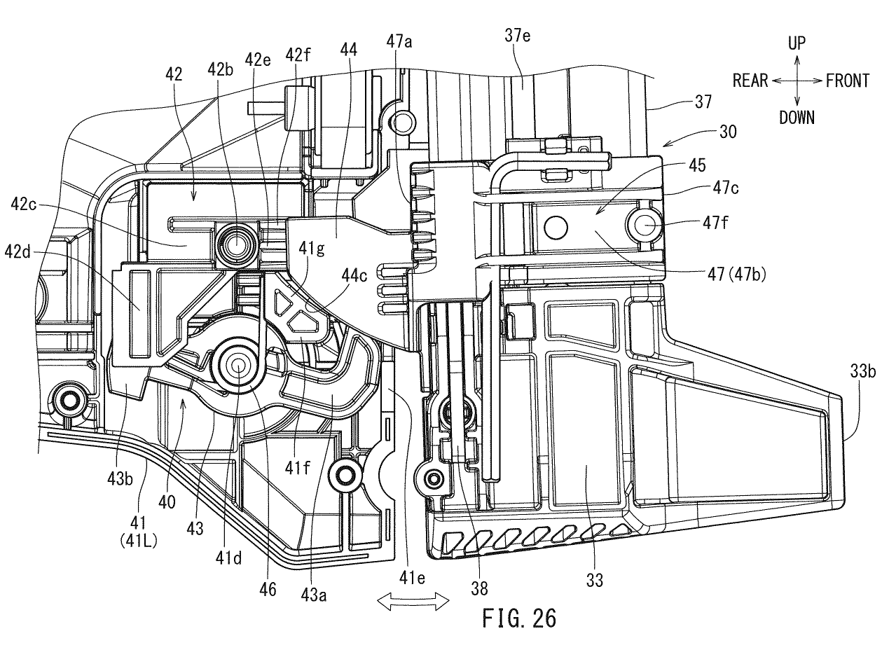

As shown in FIGS. 22 and 23, an extrusion portion 42f is provided at the front of the operation member 42. The extrusion portion 42f protrudes forward. An operation force conversion surface 42e is provided on the right side of the extrusion portion 42f. The operation force conversion surface 42e is an inclined surface projecting forward and sloping in the direction of forward displacement toward the left side. The operation force conversion surface 42e is formed, for example, by the end faces of a plurality of ribs extending diagonally upward. FIG. 26 shows three ribs forming the operation force conversion surface 42e. The operation force conversion surface 42e may alternatively be formed as a single flat inclined surface.

As shown in FIG. 24, a support shaft 41d is integrally formed in the right housing 41R of the lock housing 41. The support shaft 41d extends parallel to the support column 41a that supports the operation portion 42. The support shaft 41d has an axis perpendicular to both the feeding direction of the driving member n of the magazine main body 30 and the driving direction of the driving member n of the tool main body 10. The lock member 43 is supported so as to be rotated in the up-down direction around the support shaft 41d. The lock member 43 has a tubular support portion 43c approximately at the center in its longitudinal direction. The lock member 43 is rotatably supported by inserting the support shaft 41d into the inner periphery of the support portion 43c.

A lock arm 43a is provided at the front of the lock member 43. The lock arm 43a extends forward from the support portion 43c. A tip portion of the lock arm 43a is substantially bent upward in an L-shape. An engaging portion 43b is provided at the rear of the lock member 43. The engaging portion 43b extends rearward from the support portion 43c.

A biasing member 46 is accommodated within the inner periphery of the support portion 43c. A torsion spring is used as the biasing member 46. One end of the biasing member 46 engages the lock member 43, and the other end engages the lock housing 41 (right housing 41R). This biases the lock member 43 in a direction that moves the lock arm 43a upward (locking direction; clockwise in FIG. 22).

The engaging portion 43b of the lock member 43 is biased in a direction to move downward by the biasing member 46 (refer to FIG. 25). The operation member 42 is located above the engaging portion 43b. When the operation member 42 is at the locked position, the stopper 42d of the operation member 42 is positioned on the upper surface side of the engaging portion 43b, thereby restricting the upward displacement of the engaging portion 43b. This restricts the lock member 43 from rotating toward the unlocked side (counterclockwise direction in FIG. 22) against the biasing member 46.

When the operation member 42 is pushed to the right as shown in FIG. 23, the stopper 42d moves to the right relative to the engaging portion 43b of the lock member 43. As a result, the engaging portion 43b of the lock member 43 can move upward, thus allowing the lock member 43 to rotate to the unlocked position.

### <Magazine Holder>

The magazine holder 45 has a holder 44 extending rearward from the rear edge portion 37a of the magazine main body 37 and a support frame portion 47. The holder 44 is supported by the magazine body 37 via the support frame portion 47. As shown in FIG. 21, the lock housing 41 has a lock window 41e on the front surface of the lock housing 41. When the magazine 30 is attached or detached, the holder 44 moves in and out of the lock housing 41 through the lock window 41e.

The holder 44 is provided with a lock recess 44a, an operation force conversion surface 44b, and a lock guide 44c. The lock recess 44a and the lock guide 44c are provided on the lower surface of the holder 44. The lock guide 44c is provided adjacent to the rear side of the lock recess 44a. The operation force conversion surface 44b is provided on the left side of the holder 44.

In the stage where the magazine 30 is installed as shown in FIGS. 23 and 26, the holder 44 enters the lock housing 41 through the lock window 41e. FIGS. 23 and 26 may alternatively be regarded as showing the holder 44 being pulled out of the lock housing 41 through the lock window 41e in order to remove the magazine 30.

In the stage where the magazine 30 is installed, the operation member 42 is positioned leftward at the locked position by the biasing member 48. When the holder 44 moves into the lock housing 41, the operation force conversion surface 44b enters to the right of the operation force conversion surface 42e of the operation member 42. The operation force conversion surface 44b of the holder 44 is inclined such that its rear side is displaced to the right. Therefore, during the mounting operation of the magazine 30, the operation force conversion surface 44b is positioned almost parallel and opposite to the operation force conversion surface 42e of the operation member 42 with a slight gap, or in sliding contact with it.

In the stage when the magazine 30 is installed, the lock member 43 is rotated to an initial position beyond the lock position by the biasing force of the biasing member 46. When the lock member is at the initial position of the lock member 43, the engaging portion 43b is spaced downward from the stopper 42d of the operation member 42. Therefore, the lock member 43 is allowed to rotate toward the unlocked side.

When the holder 44 enters the lock housing 41 through the lock window 41e, the lock guide 44c contacts the lock arm 43a of the lock member 43 positioned at the initial position. The lock guide 44c is configured to have a circular arc surface whose rear side is displaced upward. Therefore, through the movement of the holder 44 into the lock housing 41, the lock arm 43a is pushed downward. This rotates the lock member 43 toward the unlocked side against the biasing force of the biasing member 46.

Through the movement of the holder 44 into the lock housing 41, the lock member 43 rotates toward the unlocked side, and accordingly the lock arm 43a moves toward the front side of the lock guide 44c. Further movement of the holder 44 disengages the lock arm 43a from a front end of the lock guide 44c. This rotates the lock member 43 toward the locking side by the biasing force of the biasing member 46, whereby the lock arm 43a enters the lock recess 44a.

The rotation of the lock member 43 to the locking side causes the lock arm 43a to be hooked onto the rear surface of the lock recess 44a, and the holder 44 is pulled into the lock housing 41 by the biasing force of the biasing member 46. This secures the magazine 30 at the mounting position as shown in FIGS. 22 and 24. In this mounting state, the upward movement of the engaging portion 43b of the lock member 43 is restricted by the stopper 42d of the operation member 42. Therefore, the lock arm 43a remains engaged in the lock recess 44a, thereby locking the magazine 30 at the mounting position.

As shown in FIGS. 22, 23, and 26, a triangular pillar-shaped attachment guide portion 41f is provided between the operation member 42 and the lock member 43. The attachment guide portion 41f is integrally formed on the inner surface of the left housing 41L. The attachment guide portion 41f is positioned approximately spanning across the left and right housings 41L and 41R of the lock housing 41. A guide surface 41g is provided at the top of the attachment guide portion 41f. The guide surface 41g is inclined upward toward the rear (toward the nose portion 20).

During the mounting of the magazine 30, the lock guide portion 44c of the holder 44 contacts the guide surface 41g of the attachment guide portion 41f. As described above, as the holder 44 is pulled into the lock housing 41 by the biasing force of the biasing member 46, the lock guide portion 44c comes into elastic contact with the guide surface 41g. This guides the magazine 30 toward the nose portion 20.

The holder 44 is pushed upward by the biasing force of the biasing member 46 via the lock member 43, thereby attaching the magazine 30 in a state where it is pushed toward the nose portion 20. This also reduces the gap between the magazine base 23 and the engaging portions 30a and 30b, thereby reducing play between the magazine 30 and the nose portion 20.

To detach the magazine 30, the operation member 42 is pushed. When the operation portion 42a of the operation member 42 is pushed to the right in the installed state of the magazine 30 shown in FIGS. 22, 24, and 25, the stopper 42d is displaced from the upper side of the engaging portion 43b of the lock member 43. This allows the lock member 43 to rotate toward the unlocked side. When the operation member 42 is pushed, the operation force conversion surface 42e is pressed against the operation force conversion surface 44b of the holder 44. This converts the pushing on the operation member 42 into a removable force that pulls the holder 44 out of the lock housing 41.

When the holder 44 is pushed in the removal direction, the lock arm 43a is pushed by the rear surface of the lock recess 44a, thereby rotating the lock member 43 toward the unlocked side. When the operation member 42 is pushed to the unlocked position as shown in FIG. 23, the holder 44 moves in the removal direction and the lock member 43 is further rotated toward the unlock side, wherein the lock arm 43a disengages from the lock recess 44a and moves to the front end of the lock guide portion 44c.

The magazine lock portion 40 is unlocked when the lock arm 43a disengages from the lock recess 44a. When detached from the lock recess 44a, the lock arm 43a is pressed against the lock guide 44c by the biasing force of the biasing member 46. Accordingly, the biasing member 46 acts as a force to displace the magazine 30 in the removal direction via the holder section 44. This pushes the magazine 30 in the removal direction. In this way, the magazine 30 is removed in two stages: first, displacement in the removal direction by pushing the operation member 42, and second, being pushed out by the biasing force of the biasing member 46 acting through the lock member 43.

As shown in FIGS. 18, 19, and 20, a support frame portion 47 is integrally formed with the holder 44. The support frame portion 47 has a U-shaped cross section including a rear holder portion 47a, a first side surface portion 47b, and a front holder portion 47c. The rear holder portion 47a is overlapped along the rear edge portion 37a of the magazine main body 37. The holder 44 protrudes rearward (toward the tool main body 10) from the rear holder portion 47a.

A second side surface portion 47g is provided at the top of the rear holder portion 47a. The second side surface portion 47g is provided at two locations: upper and lower. The upper and lower second side portions 47g bend forward in an L-shape from the upper portion of the rear holder 47a. The upper and lower second side portions 47g extend outward so as to cover the second side portion 37f (left side portion) of the magazine main body 37.

The first side portion 47b of the support frame portion 47 is placed overlapping the first side surface 37e (right side portion) of the magazine main body 37. The front holder portion 47c is provided along the front edge portion 37b of the magazine main body 37, standing upward to the left from the front end of the first side surface portion 47b to the left. By clamping the magazine body 37 between the rear holder portion 47a and the front holder portion 47c of the support frame portion 47, the magazine holder 45 is mounted so as to extend from the front edge portion 37b, across the first side portion 37e, to the rear edge portion 37a of the magazine body 37. Furthermore, a region between the first side surface portion 37e (right side portion) and the second side surface portion 37f (left side portion) of the magazine main body 37 is clamped by the first side surface portion 47b and the second side surface portion 47g of the magazine holder 45, whereby the magazine holder 45 is mounted to the magazine main body 37.

### <Clip Attachment to the Magazine Holder>

The magazine holder 45 is attached more firmly to the magazine main body 37 by a metal clip 50. The clip 50 has an inverted U-shaped clamping portion 50a and a protruding plate 50b protruding from the rear of the clamping portion 50a. The protruding plate 50b has an insertion hole 50c through which a fixing screw 51 is inserted. A rectangular, one-step lower attachment seat 47h is provided on the upper surface of the holder 44. A screw hole 47i is provided at the center of the attachment seat 47h. The protruding plate 50b is fitted into the attachment seat 47h and a fixing screw 51 is screwed into the screw hole 47i, thereby coupling the protruding plate 50b to the upper surface of the holder section 44. As a result, the clip 50 is coupled to the holder 44.

The clamping portion 50a has a first plate 50aa that contacts the magazine main body 37 and a second plate 50ab that contacts the magazine holder 45. The clamping portion 50a has elasticity that biases the first plate 50aa and the second plate 50ab toward each other. As shown in FIG. 19, the upper portion of the rear edge portion 37a (second side surface 37f) of the magazine body 37 and the upper portion of the rear holder portion 47a of the support frame 47 are elastically clamped in the front-rear direction by the elastic force of the clamping portion 50a. As a result, the support frame 47, particularly the rear holder portion 47a, is firmly coupled to the rear edge portion 37a of the magazine body 37, thereby reliably restricting rearward displacement of the holder 44, particularly displacement away from the magazine body 37.

As shown in FIGS. 18 and 20, the upper portion (second side surface portion 47g) of the rear holder portion 47a of the support frame portion 47 has an upper wall portion 47d and a lower wall portion 47e. The clamping portion 50a of the clip 50 is accommodated between the upper wall portion 47d and the lower wall portion 47e with substantially no play. The protruding plate 50b of the clip 50 is screwed to the left side of the holder section 44 by fixing screws 51. As a result, the clip 50 is firmly coupled to the holder 44 and the support frame portion 47, whereby misalignment of the holder 44 with respect to the magazine 30 is reliably reduced.

A screw fastening portion 47f is provided on the front holder portion 47c of the support frame portion 47. A fixing screw 52 is screwed into the screw fastening portion 47f. A portion of the head of the fixing screw 52 is in contact with the semicircular screw receiving portion 37c in the magazine main body 37. As a result, positional displacement of the support frame 47, particularly the front holder portion 47c, relative to the front edge portion 37b of the magazine body 37 is restricted. This restricts positional displacement of the magazine holder 45 relative to the magazine main body 37. By restricting the positional displacement of the magazine holder 45, the durability of the magazine lock portion 40 is improved.

According to the embodiment described above, the electric driving tool 1 has the driver 15 that drives the driving member n, the lift mechanism 25 that returns the driver 15 in the direction opposite to the driving direction, and the reduction gear train 81 that reduces the output of the electric motor 26 and transmits it to the lift mechanism 25. Furthermore, the electric driving tool 1 has the gear housing 80 that houses the reduction gear train 81 and the main body housing 11 that houses the gear housing 80. Furthermore, the electric driving tool 1 has the first bearing 83 that is directly held in the main body housing 11 and supports the lower portion (first portion) of the motor shaft 26c of the electric motor 26, and the bearing holder 84 that holds the second bearing 82 supporting the upper portion (second portion) of the motor shaft 26c and engages the opening 80a of the gear housing 80.

Accordingly, the motor housing can be omitted to reduce the weight of the driving tool 1, while the misalignment of the motor shaft 26c can be suppressed, thereby reducing the contact of the rotor 26b with the stator 26a (core rubbing).

According to the embodiment, the bearing holder 84 has the first annular portion 84a (supported portion) protruding from the gear housing 80 and supported by the main body housing 11. Therefore, the bearing holder 84 engages the gear housing 80 and is supported by the main body housing 11 via the first annular portion 84a, thereby more reliably reducing the misalignment of the bearing 82 (second bearing).

According to the embodiment, the bearing holder 84 has the anti-rotation portion 84c that engages the main body housing 11. Accordingly, the bearing holder 84 is prevented from rotating relative to the main body housing 11.

According to the embodiment, the bearing holder 84 is formed of a single member having the first annular portion 84a and the second annular portion 84b. The first annular portion 84a is supported by the main body housing 11 and the second annular portion 84b engages (fits into) the gear housing 80. Therefore, the bearing holder 84 is supported by both the main body housing 11 and the gear housing 80.

According to the embodiment, the first annular portion 84a of the bearing holder 84 has the anti-rotation portion 84c with a convex or concave shape on an outer peripheral surface thereof, and the anti-rotation portion 84c is configured to engage the main body housing 11 to prevent the bearing holder 84 from rotating relative to the main body housing 11. Accordingly, the bearing holder 84 is prevented from rotating relative to the main body housing 11 by the anti-rotation portion 84c of the first annular portion 84a.

According to the embodiment, the stator 26a of the electric motor 26 is directly supported by the main body housing 11. Therefore, the misalignment of the stator 26a with respect to the main body housing 11 is suppressed.

According to the embodiment, the main body housing 11 is divided into two half housings (the left-right half-split housings 11L, 11R) along the thickness direction (right and left direction) of the tool main body. Accordingly, the main body housing 11 has a half-split configuration, whereby assembly and maintenance of the electric motor 26 and its peripheral components are ensured.

According to the embodiment, the two sections of the main body housing 11 (the left-right half-split housings 11L, 11R) are combined with each other by the first fixing element 87 and the second fixing element 89. The first fixing element 87 is located on a first plane perpendicular to the axial direction of both the motor shaft 26c and the first bearing 83. The second fixing element 89 is located on a second plane perpendicular to the axial direction of both the motor shaft 26c and the second bearing 82. Therefore, the misalignment of the first bearing 83 and the second bearing 82 relative to the main body housing 11 is more reliably suppressed.

According to the embodiment, the bearing holder 84 is made of aluminum. Accordingly, the driving tool 1 is reduced in weight.

According to the embodiment, the driving tool 1 has the piston 13 that is moved by the lift mechanism 25 and the accumulation chamber 14 in which gas pressure is increased by the piston 13, and the driver 15 drives the driving member n by utilizing the gas pressure in the accumulation chamber 14. Therefore, in the gas-spring-type driving tool 1, core rubbing is suppressed while weight reduction is achieved.

According to the embodiment, the contact top 22 has the retention mechanism 60 that prevents the contact top 22 from slipping out of the nose portion 20. The retention mechanism 60 has the lock surface 63d on the driver guide 21 (tool main body 10 side) and the stopper surface 22e on the contact top 22. The lock surface 63d and the stopper surface 22e face each other in the driving direction and in a direction that intersects the driving direction.

Accordingly, an impact applied to the contact top 22 in the driving direction is added to the nose portion 20 when the stopper surface 22e contacts the lock surface 63d. The lock surface 63d and the stopper surface 22e face each other in the driving direction and also in the direction that intersects in the driving direction (cross direction). Therefore, the added impact acts as an external force P in a direction that brings the nose portion 20 (retention mechanism 60) closer to the contact top 22 via the lock surface 63d. This suppresses damage to the retention mechanism 60 and nose portion 20, thereby improving their durability.

According to the embodiment, the retention mechanism 60 has the lock member 63 provided with the lock surface 63d. The lock member 63 is movable in a direction that intersects both the driving direction and the cross direction. The lock member 63 moves between the locked position that prevents the contact top 22 from slipping out of the nose portion 20 and the unlocked position that allows the contact top 22 to slip out of the nose portion 20. Therefore, the contact top 22 can be attached to and removed from the nose portion 20 by operation of the lock member 63.

According to the embodiment, the lock surface 63d and the stopper surface 22e are inclined surfaces having directional component in the driving direction and the cross direction. Therefore, the impact added to the contact top 22 is efficiently converted into an external force component in a direction toward bringing the nose portion 20 closer to the contact top 22.

According to the embodiment, the magazine 30, in which the driving members N (connected driving members N) are loaded, is located below the nose portion 20, and the retention mechanism 60 is located above the nose portion 20. Accordingly, the contact top 22 and magazine 30 are compactly arranged in relation to the nose portion 20.

According to the embodiment, the contact top 22 has a cylindrical shape. Therefore, the strength of the contact top 22 is increased.

According to the embodiment, the contact top 22 has the first spring 74 and the second spring 75 that bias the contact top 22 in the driving direction. Therefore, the combined biasing force of the first spring 74 and the second spring 75 ensures that the contact top 22 is reliably returned to the off position in the driving direction. In other words, the combined biasing force of the first spring 74 and the second spring 75 prevents the contact top 22 from inadvertently moving toward the on position. By using, for example, two springs having a small biasing force and a longer service life than a single high-force spring, durability can be ensured while achieving a large total biasing force.

According to the embodiment, the first spring 74 and the second spring 75 are coil springs with different diameters and are arranged to overlap each other in the radial direction. Therefore, the space for accommodating the outer spring (first spring 74) and inner spring (second spring 75) can be made compact.

According to the embodiment, the winding directions of the first spring 74 and the second spring 75 are opposite. Therefore, entanglement between the outer spring (first spring 74) and the inner spring (second spring 75) is prevented.

According to the embodiment, the tip portion 22f of the contact top 22 is enlarged in diameter. Therefore, a clearance space for the collated strip s of the connected driving members N is secured during driving, ensuring the driving depth of the driving members.

According to the embodiment, the driving tool 1 is a concrete nailer for driving the driving members N into concrete. Therefore, the durability of the nose portion 20 that supports the detachable contact top 22 is enhanced in the concrete nailer.

According to the embodiment, the driving tool 1 has the tool main body 10 equipped with the nose portion 20 from which the driving member n is ejected, and the magazine main body 10 that can be attached to and detached from the tool main body 30. The magazine 30 has the magazine main body 37 that houses the driving member n and the magazine holder 45 made of a different material from the magazine main body 37. The magazine 30 has the clip 50 that includes the first plate 50aa contacting the magazine main body 37 and the second plate 50ab contacting the magazine holder 45, and the clip 50 resiliently clamps between the magazine main body 37 and the magazine holder 45 by its resilient force. Furthermore, the tool main body 10 has the magazine lock portion 40 that locks the magazine holder 45 to the tool main body 10.

Accordingly, the attachment strength between the magazine holder 45 and the magazine main body 37 is increased by the clip 50, thereby enhancing the durability of the magazine lock portion 40 including the magazine holder 45.

According to the embodiment, the magazine 30 is biased toward the nose portion 20 via the magazine holder 45 when the magazine 30 is installed. Therefore, the attachment strength between the magazine 30 and the tool main body 10 is increased.

According to the embodiment, the clip 50 has the fixing screw 51 that fixes the clip 50 to the magazine holder 45. Therefore, the clip 50 is securely attached to the magazine holder 45.

According to the embodiment, the magazine holder 45 has the holder 44 (protruding portion) that is locked to the magazine lock portion 40. The clip 50 is fastened with a screw to the protruding portion of the magazine holder 45. Therefore, the clip 50 is securely attached to the magazine holder 45.

According to the embodiment, the magazine main body 37 has the rear edge portion 37a that is perpendicular to the driving direction on the rear side of the direction in which the tool main body 10 drives the driving member n. The clip 50 is attached to the rear edge portion 37a. Therefore, the clip 50 increases the attachment strength between the magazine holder 45 and the rear edge portion 37a of the magazine main body 37.

According to the embodiment, the magazine main body 37 has the front edge portion 37b perpendicular to the driving direction on the front side of the direction in which the tool main body 10 drives member n. The magazine holder 45 is fastened with a screw to the front edge portion 37b. Therefore, the attachment strength between the magazine holder 45 and the front edge portion 37b of the magazine main body 37 is enhanced.

According to the embodiment, the magazine holder 45 has the front holder 47c covering the front surface (front edge portion 37b) of the magazine main body 37, the rear holder 47a covering the rear surface (rear edge portion 37a) of the magazine main body 37, and the first side portion 47b connecting the front holder portion 47c and rear holder portion 47a and covering the right side 37e (first side surface) of the magazine body 37. Accordingly, the magazine holder 45 is mounted across a range extending from the front surface of the magazine main body 37, through the first side surface to the rear surface.

According to the embodiment, the magazine holder 45 has the second side portion 47g that extends from the rear holder 47a and covers the second side surface 37f of the magazine main body 37. Therefore, the magazine main body 37 is clamped between its front and rear sides by the front holder 47c and the rear holder 47a. In addition, the first side surface 37e and the second side surface 37f of the magazine main body 37 are clamped between the first side portion 47b and the second side portion 47g of the magazine holder 45.

According to the embodiment, the magazine main body 37 is made of aluminum and the magazine holder 45 is made of resin. Accordingly, weight reduction of the magazine 30 is achieved.

According to the embodiment, the driving tool 1 is a gas-spring-type driving tool 1 having the piston 13, the cylinder 12 equipped with the pressure accumulation chamber 14 whose gas pressure is increased by the piston 13, and the driver 15 that drives the driving member n utilizing the gas pressure in the accumulation chamber 14. Therefore, the durability of the magazine lock portion 40 can be improved for the detachable magazine 30 in the gas-spring-type driving tool 1.

According to the embodiment, the driving tool 1 has the driver main body 16, which is circular in cross section and drives a driving member n, a plurality of rack teeth 17 protruding radially from the driver main body 16 and aligned longitudinally of the driver main body 16, and the lifter 27 that moves the driver main body 16 in the direction opposite to the driving direction by sequentially engaging the plurality of rack teeth 17.

The driving tool 1 has the piston 13 that moves with the driver main body 16 in the direction opposite to the driving direction to increase the gas pressure in the accumulation chamber 14, and the first recess 16a and the second recess 16b both recessed in the driver main body 16 along its longitudinal direction. The driving tool 1 has the first guide 18 and the second guide 19 that protrude into the first recess 16a and the second recess 16b, respectively, so as to restrict the rotation of the driver main body 16 and guide the movement of the driver main body 16 in the driving direction.

Therefore, the first guide 18 and the second guide 19 restrict the rotation of the driver main body 16 around the driving axis D, thereby enhancing the durability of the driver 15.

According to the embodiment, both the first recess 16a and the second recess 16b are located on the rack teeth 17 side of the driver main body 16 rather than the center of the driver body 16 (driving axis D). Therefore, the rotation of the driver main body 16 is efficiently restricted against external forces acting on the rack teeth 17.

According to the embodiment, the first recess 16a and the second recess 16b have a symmetrical position and shape relative to the virtual plane K that passes through the center of the driver main body 16 (driving axis D) and includes the protruding direction of the rack teeth 17. Therefore, the rotation of the driver main body 16 in both directions is efficiently restricted.

According to the embodiment, the first recess 16a and the second recess 16b have bottom surfaces 16c and 16d, respectively, perpendicular to the protruding direction of the rack teeth 17. Therefore, the first guide 18 and second guide 19 efficiently restrict the rotation of the driver main body 16 and its displacement toward the rack teeth 17.

According to the embodiment, the first recess 16a and the second recess 16b are positioned on opposite sides of the rack teeth 17 in the thickness direction and are spaced approximately equal to the thickness d of the rack teeth 17. Accordingly, the rotation of the driver main body 16 in both directions is more reliably restricted.

According to the embodiment, the first recess 16a and the second recess 16b respectively extend to the tip portion 16i in the driving direction of the driver 15. Therefore, the rotation of the driver main body 16 is restricted within a range in which the driver 15 moves toward the moving end in the direction opposite to the driving direction

According to the embodiment, the driver main body 16 has the flat surface 16e extending longitudinally on the side opposite to the rack teeth 17. The guide surface 20b facing the flat surface 16e is provided on the driver guide 21 of the tool main body 1 Accordingly, the rotation of the driver main body 16 is restricted by the flat surface 16e facing the guide surface 20b.

According to the embodiment, the driver main body 16 has three outer circumferential arc surfaces of the same diameter, each between the first recess 16a, the second recess 16b and the flat surface 16e. Therefore, the cross-sectional shape of the driver main body 16 and the driving passage 20a of the driver guide 21 that guides the driver body 16 in the driving direction can be simplified to a substantially circular cross-section.

According to the embodiment, the cross-sectional shape of the driver main body 16 includes a polygonal portion located on the inner circumference of a substantially circular cross-sectional shape over at least 180° around the driving axis D (C1 region). Therefore, when the driver main body 16 has, over at least 180° around the driving axis D, a polygonal cross-sectional shape located on the inner side of a circular shape rather than a flat shape, the rotation of the driver main body 16 can be restricted by providing the first recess 16a and the second recess 16b. In a case where the driver main body 16 has a polygonal cross-sectional shape located on the inner side of one circle over a range of at least 180° around the driving axis D, and the driver guide 21 (driving passage 20a) does not have a corresponding polygonal inner surface, omission of either the first recess 16a or the second recess 16b results in the rotation (twisting) of the driver main body 16 in one direction not being restricted. As illustrated in the embodiment, by providing both the first recess 16a and the second recess 16b, twisting of the driver main body 16 in both directions around the driving axis D is restricted.

According to the embodiment, the driving tool 1 is a concrete nailer for driving the driving member n into concrete. Therefore, the driver 15 exhibits improved durability when used in a concrete nailer.

According to the embodiment, the driving tool 1 has the driver main body 16, which is circular in cross section and drives a driving member n, a plurality of rack teeth 17 protruding radially from the driver main body 16 and aligned longitudinally of the driver main body 16, and the lifter 27 that moves the driver main body 16 in the direction opposite to the driving direction by successively engaging the plurality of rack teeth 17. The driving tool 1 has the piston 13 that moves with the driver main body 16 in the direction opposite to the driving direction to increase the gas pressure in the accumulation chamber 14, and the driver guide 21 that guides the driver body 16 in the driving direction. The driving tool 1 has a restricting structure (the first recess 16a and the second recess 16b) between the driver main body 16 and the driver guide 21 that restricts the rotation of the driver main body 16 around its center axis (driving axis D) and the movement of the driver body 16 toward the rack teeth 17. Accordingly, the durability of the driver 15 is enhanced by the restricting structure.

Various changes can be made to the embodiment described above. In the embodiment, a concave anti-rotation portion 84c is provided in the first annular portion 84a of the bearing holder 84 and convex engagement projections 85a and 86a are provided in the holder receiving portions 85 and 86 of the main body housing 11. However, a convex anti-rotation portion may be provided on the bearing holder 84 and a concave engagement recess may be provided in the holder receiving portion of the main housing 11.

Furthermore, the first annular portion 84a and the second annular portion 84b of the bearing holder 84 may be modified to have the same diameter. Alternatively, the first annular portion may be modified to have a smaller diameter than the second annular portion. Instead of forming the first annular portion 84a and the second annular portion 84b as a single member, they may be formed as separate components and assembled together.

Instead of being made of aluminum, the bearing holder 84 may be made of steel or another metal.

Furthermore, various changes can be made to the embodiments described above. In the embodiment, the retention portion 63b moves the arm 63c in the left-right direction for moving to the locked position and unlocked position. However, a retention portion may move in the up-down direction for moving upward to the unlocked position and downward to the locked position. In this case, the arm that moves the retention portion can be modified to a push button or lever that operates in the up-down direction.

Furthermore, in the retention mechanism 60, both the stopper surface 22e of the stopper portion 22d and the lock surface 63d of the lock member 63 are inclined downward toward the rear, and the stopper surface 22e and the lock surface 63d are mutually positioned parallel to each other and in contact with each other. However, one of the surfaces may be modified to be a surface perpendicular to the driving direction.

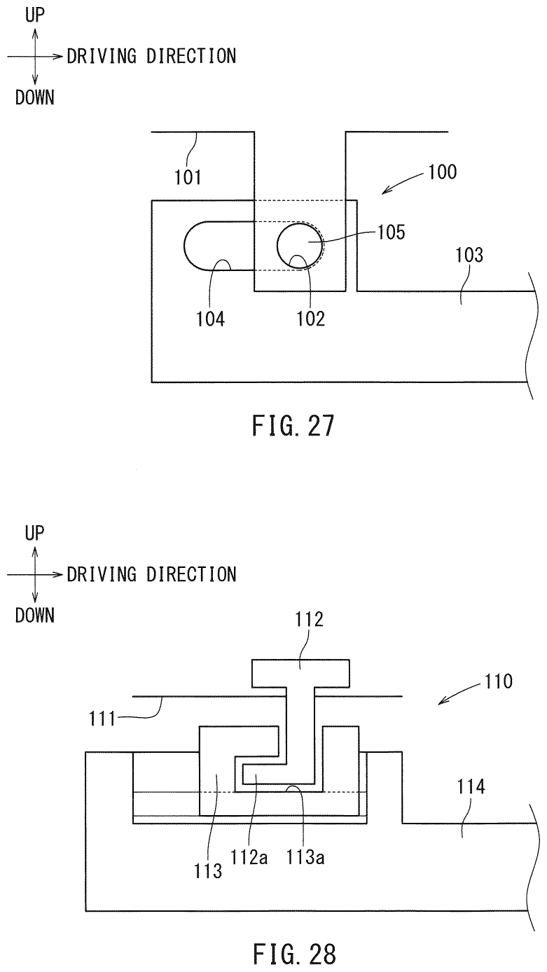

In the embodiment, the stopper surface 22e is in contact with the lock surface 63d of the lock member 63, each of which is inclined to the axis of the contact top 22 (in the driving direction), to restrict the contact top 22 from slipping out of the driver guide 21. Alternatively, as illustrated in FIG. 27, a retention mechanism 100 can be used, in which a lock pin 105 can be inserted into and removed from a circular lock hole 102 provided on the driver guide 101 and a long-groove shaped connection hole 104 on the contact top 103. In this case, the lock pin 105 is provided to be movable between the locked and unlocked positions by moving it in a direction perpendicular to both the driving direction and the up-down direction ((i.e., the direction perpendicular to the plane of the drawing; the left-right direction). The outer circumference surface of the lock pin 105 corresponds to the lock surface 63d, and the inner circumference surface of the connection hole 104 corresponds to the stopper surface 22e.

According to the retention mechanism 100, the contact top 103 can be removed from the driver guide 101 by moving the lock pin 105 toward the unlock position and pulling it out of the lock hole 102 and the connection hole 104. By moving the lock pin 105 to the locked position and inserting it into both the lock hole 102 and the connection hole 104, the contact top 103 is movable in the front-rear direction within a certain range and cannot be removed from the driver guide 101. Even if a large impact is applied in the driving direction due to a jammed nail while the contact top 103 is coupled, a large displacement on the driver guide 101 side can be suppressed and damage to the retention mechanism 100 can be prevented.

Instead of the retention mechanisms 60 and 100, a retention mechanism 110 illustrated in FIG. 28 can be provided. The retention mechanism 110 has a lock slider 112 on the driver guide 111 side and a slider receiving portion 113 on the contact top 114 side. The lock slider 112 can slide in a direction perpendicular to both the driving direction and the up-down direction (i.e., the direction perpendicular to the plane of the drawing; the left-right direction) relative to the driver guide 111. The engaging portion 112a of the lock slider 112 corresponds to the lock surface 63d, and the engaging recess 113a of the slider receiving portion 113 corresponds to the stopper surface 22e.

The slider receiving portion 113 is slidable within a certain range in the driving direction relative to the contact top 114. The slider receiving portion 113 is provided with an L-shaped engaging recess 113a. The engaging recess 113a is formed so as to extend through in the left-right direction. An L-shaped engaging portion 112a is provided in the lower portion of the lock slider 112. When the lock slider 112 moves in a direction perpendicular to the plane of the drawing, the engaging portion 112a moves into and out of the engaging recess 113a.

The contact top 114 can be removed from the driver guide 111 by operating the lock slider 112 to the unlocked state in which the engaging portion 112a is disengaged from the engaging recess 113a. By moving the lock slider 112 toward the locked position and operating it to the locked state where the engaging portion 112a is positioned within the engaging recess 113a, the contact top 114 is coupled with the driver guide 111 in such a way that it cannot be removed from the driver guide 111. Even when a large impact in the driving direction is applied due to nail jamming or the like in the coupled state of the contact top 114, the engagement between the engagement portion 112a and the engagement recess 113a is maintained, thereby suppressing a large displacement of the driver guide 111 side and preventing damage to the retention mechanism 110.

Furthermore, various changes can be made to the embodiment described above. In the embodiment, the front holder portion 47c of the support frame portion 47 is coupled to the front edge portion 37b of the magazine main body 37 by contacting the head of the fixing screw 52 to the screw receiving portion 37c of the magazine body 37. However, the front holder portion 47c and the front edge portion 37b may be configured to extend through in the front-rear direction and the front holder portion 47c is fastened to the front edge portion 37b with the fixing screw 52.

In the embodiment, the protruding plate 50b of the clip 50 is fastened to the upper surface of the holder 44 with the fixing screw 51. However, the clip may be integrally formed with the holder 44 by insert molding, for example. By this configuration, the magazine holder 45 can be firmly attached to the magazine main body 37 by elastically clamping the rear edge portion 37a and the front holder portion 47c with the clamping portion 50a.

Furthermore, various modifications can be made to the above-described embodiment. For example, in the illustrated embodiment, the C1 region around the driving axis D is shown as one example of a substantially circular cross-sectional shape, having a substantially polygonal section with a flat surface 16e and a lower surface 16j in the longitudinal E region. In the longitudinal F region, the section additionally includes an upper surface 16f and upper and lower inclined rear surfaces 16g and 16h. Alternatively, the C1 region may have a purely circular cross-sectional shape without these flat surfaces, while applying the first recess 16a and the second recess 16b.

In the illustrated embodiment, the first recess 16a and the second recess 16b extend to the tip 16i. However, these recesses may be omitted in the region from the tip 16i to the foremost rack tooth 17. It is sufficient that the first and second recesses, together with the first and second guides, extend through the region where the plurality of rack teeth 17 is provided.

In the illustrated embodiment, the lifter 27 has eight engaging portions 27a and the driver 15 has eight rack teeth 17. The guide structure of the driver illustrated in this embodiment may also be applied to other lift mechanisms having an arbitrary number of engaging portions and rack teeth.

In the illustrated embodiment, the first recess 16a and the second recess 16b are provided on the rack teeth side relative to the center of the driver main body 16 (driving axis D). Alternatively, the first recess on the upper side or the second recess on the lower side of the rack teeth 17 may be provided on the opposite side (left side) relative to the driving axis D. In this case, the corresponding one of the two guides on the driver guide 21 side is positioned on the opposite side of the rack teeth 17.

In the illustrated embodiment, a gas spring type driving tool is illustrated as a driving tool 1. The retention mechanisms 60, 100, 110, the clip-fastening structure of the magazine holder 45 in the detachable magazine 30, and the magazine lock portion 40 can also be applied to a compressed air type driving tool driven by externally supplied compressed air, a mechanical spring type driving tool utilizing the thrust of a compression spring as the driving force, or an electric flywheel type driving tool.

What is claimed is:

1. A driving tool comprising:
an electric motor including a stator, a rotor, and a motor shaft;
a driver configured to drive a driving member in a driving direction;
a lift mechanism configured to move the driver in a direction opposite to the driving direction;
a reduction gear train configured to reduce an output of the electric motor and transmits the output of the electric motor to the lift mechanism;
a gear housing that houses the reduction gear train;
a main body housing that houses the gear housing;
a first bearing that is directly held in the main body housing, the first bearing supporting a first portion of the motor shaft; and
a bearing holder that holds a second bearing supporting a second portion of the motor shaft, the bearing holder engaging the gear housing.

2. The driving tool according to claim 1, further comprising a supported portion provided in the bearing holder, the supported portion configured to protrude outward from the gear housing and be supported by the main body housing.

3. The driving tool according to claim 1, further comprising an anti-rotation portion on the bearing holder, the anti-rotation portion configured to engage the main body housing to prevent the bearing holder from rotating relative to the main body housing.

4. The driving tool according to claim 1, wherein
the bearing holder is formed of a single member having a first annular portion and a second annular portion,
the first annular portion acts as a supported portion supported by the main body housing, and
the second annular portion fits into the gear housing.

5. The driving tool according to claim 4, wherein the first annular portion of the bearing holder has an anti-rotation portion with a convex or concave shape on an outer peripheral surface thereof, the anti-rotation portion being configured to engage the main body housing to prevent the bearing holder from rotating relative to the main body housing.

6. The driving tool according to claim 1, wherein the stator of the electric motor is directly supported by the main body housing.

7. The driving tool according to claim 1, wherein the main body housing is divided into two half housings along a thickness direction of the main body housing.

8. The driving tool according to claim 7, wherein
the two half housings of the main body housing are combined with each other by a first fixing element and a second fixing element,
the first fixing element is located on a first plane perpendicular to an axial direction of both the motor shaft and the first bearing, and
the second fixing element is located on a second plane perpendicular to the axial direction of both motor shaft and the second bearing.

9. The driving tool according to claim 1, wherein the bearing holder is made of aluminum.

10. The driving tool according to claim 1, further comprising:
a piston configured to be moved by the lift mechanism; and
an accumulation chamber in which gas pressure is increased by movement of the piston,
wherein the driver drives the driving member by utilizing the gas pressure in the accumulation chamber.

11. The driving tool according to claim 5, wherein the anti-rotation portion comprises a plurality of anti-rotation portions arranged at equal intervals on the outer peripheral surface of the first annular portion.

12. The driving tool according to claim 11, wherein the main body housing includes a holder receiving portion having engagement portions with a concave or convex shape on an inner peripheral surface thereof, the engagement portions engaging the plurality of anti-rotation portions.

13. The driving tool according to claim 12, wherein the plurality of anti-rotation portions are formed as V-shaped recesses, and the engagement portions are formed as V-shaped projections configured to engage the V-shaped recesses.

14. The driving tool according to claim 12, wherein the holder receiving portion is provided in each of two half housings into which the main body housing is divided along a thickness direction thereof.

15. The driving tool according to claim 14, wherein each holder receiving portion is provided with an equal number of engagement portions.

16. The driving tool according to claim 12, wherein
the plurality of anti-rotation portions comprises four anti-rotation portions arranged on the bearing holder, and
the engagement portions comprises four engagement portions arranged on the main body housing and configured to engage the four anti-rotation portions.

17. The driving tool according to claim 4, wherein the second annular portion fits into a circular opening at a lower portion of the gear housing via a spigot joint.

18. The driving tool according to claim 4, wherein the first annular portion has a larger diameter than the second annular portion.

19. The driving tool according to claim 1, wherein
the reduction gear train comprises three-stage planetary gears, and
the gear housing houses the three-stage planetary gears and a one-way clutch interposed between a first-stage planetary gear and a second-stage planetary gear.

20. The driving tool according to claim 1, wherein the driving tool is selected from the group consisting of a gas spring type tool, a compressed air type tool, a mechanical spring type tool, and an electric flywheel tool.
